(19) United States
(12) Patent Application Publication
(10) Pub. No.: US 2018/0078000 A1
(43) Pub. Date: Mar. 22, 2018

(54) Method to Produce an Item of Footwear with Improved Wearing Comfort, and Item of Footwear Produced According to this Method

(71) Applicant: Europlasma NV, Oudenaarde (BE)

(72) Inventors: Filip Legein, Keerbergen (BE); Eva Rogge, Kruishoutem (BE)

(21) Appl. No.: 15/519,209

(22) PCT Filed: Oct. 16, 2015
(86) PCT No.: PCT/EP2015/074062

§ 371 Date: Apr. 14, 2017

(30) Foreign Application Priority Data
Oct. 16, 2014 (EP) 14189138.2
Sep. 25, 2015 (EP) 15186960.9

(51) Int. Cl. A43D 95/06; B05D 5/08; B05D 1/00; B05D 3/04; A43B 7/12

(52) U.S. Cl. CPC A43D 95/06; B05D 5/08; A43B 7/12; B05D 3/0493; B05D 1/62

(57) ABSTRACT

The present invention concerns a method for coating outer, internal and inner surfaces of an item of footwear with a water- and/or oil-repellent coating by a low-pressure plasma polymerization coating process, by degassing the item of footwear prior to said coating process.

### TECHNICAL FIELD

The present invention relates to items of footwear with improved comfort to the wearer, such as reduction of uptake of liquid into the fabric material of which the footwear is made, leading to reduction of weight gain during use and quick drying effect, and such as keeping the wearer's feet dry. Quick drying effect has clear benefits for running and water sports. When used in colder or wet environments, such as hiking, skiing, mountain climbing and the like, a dry fabric material will also prevent the feet from cooling down and becoming damp. The present invention also relates to innovative methods to produce such an item of footwear.

### BACKGROUND OF THE INVENTION

The footwear industry is a large industry. Footwear for many applications is produced and sold on a world wide scale. For each application, the construction and design of the footwear may be different. Also the materials used to manufacture the item of footwear may be different.

For example, sports shoes need to be light and breathable and have quick drying properties for optimal sweat and moisture regulation, and are often made of synthetic materials and porous structures. Upon use of the sports footwear, weight gain due to water take up is highly unwanted. Also breathability is needed to avoid damp and wet feet, since this increases friction of the skin with the sock and shoe, leading to pain and blisters at the friction points of the foot.

Sports shoes for water sports need to have a quick drying effect after use and reduced weight gain during use for optimal comfort for the wearer since the feet stay dry and the footwear doesn't become heavy due to saturation with water. Reduced weight gain in terms of reduced absorption of water, and quick drying effect are especially beneficial in water sports at sea, since the salty water tends to leave stains on the items of footwear upon drying. When less or no water is absorbed, drying stains will not occur.

Footwear for personal protective equipment need to be liquid repellent and resistant to avoid penetration of hazardous liquids, and have often reinforcements to protect the feet against injuries.

Footwear for hiking, skiing and mountain climbing need to be as waterproof as possible to reduce the water ingress into the fabric material of which the footwear is made, since humid footwear may lead to wet or damp feet, and in cold conditions cold feet as well.

Fashion footwear is all about design and wearer comfort. This type of footwear may be made of a wide range of materials. Wearer comfort is evaluated by end customers in function of support when worn, breathability, dry and warm but yet not damp or wet feet, light weight, and protection against stains. For example, when walking in snow, rain or on the beach, absorbed water may leave stains after drying.

Several documents describe a way to keep the feet dry from moisture, rain and humidity in the atmosphere. Other documents describe ways to reduce the weight gain of footwear during use, for example running, hiking and the like.

EP0263665 describes a waterproof, water-vapour permeable fabric construction, where a porous PTFE membrane, which is waterproof and water vapour permeable, is laminated to a non-waterproof fabric construction, made of polyester (PES), polyamide (PA, nylon) or the like. The structure may be used for hats and shoes. When used in shoes, the non-waterproof fabric construction is the outer structure and the membrane is on the inside and invisible to the end user. Footwear comprising this structure, will keep the feet dry. But on the other hand, the outer fabric is non-waterproof, and may take up liquids, water, rain and the like, and gain weight. Further, when this outer fabric is humid, it may cause cooling down of the feet during use, especially in colder environments.

JPH0670804 (A) describes the use of a waterproof, water vapour permeable bag-like or sock-like structure that is placed inside the item of footwear to protect the feet from getting wet. The bag-like structure is a laminate of a polyurethane resin film or membrane and a protective fabric. The bag-like structure has a fixed position within the item of footwear. JPH0759604 (A) describe a similar bag-like structure, but which may be removed from the footwear for washing, drying, etc. The outer fabric may be non-waterproof, and may take up liquids and humidity, and gain weight. Further, liquids that penetrated the outer structure may accumulate in the space between the bag-like structure and the outer fabric, which may cause cooling down of the feet during use, especially in colder environments. Breathability of such membranes is limited in order to guarantee sufficient waterproofness. Limited breathability will reduce the release of heat and humidity from the feet to the outside.

U.S. Pat. No. 6,065,227 describes an item of footwear that comprises a waterproof membrane lining on the inside of the upper portion of the footwear. Lower portion, upper portion and inner lining are joined together by seams, which penetrate the waterproof lining. The seams are sealed with a waterproof tape. Footwear according to U.S. Pat. No. 6,065,227 will keep the feet dry. On the other hand, the outer material may take up liquids, water, etc. and may gain weight. Further, when this outer material is humid, it may cause cooling down of the feet during use, especially in colder environments and especially with leather as outer material, since wet leather has a cold touch. The combination of membrane lining and seams will limit the breathability of the footwear, which will reduce the release of heat and humidity from the feet to the outside.

WO2007/007369 describes footwear which comprises a waterproof membrane lining that is positioned at the inside of the item of footwear, and is glued to the outer fabric of the footwear. The manufacture process is rather complex, and a suitable adhesive that is waterproof is needed. Footwear comprising this structure, will keep the feet dry. But on the other hand, the outer fabric is non-waterproof, and may take up liquids, water, rain and the like, and gain weight. Further, when this outer fabric is humid, it may cause cooling down of the feet during use, especially in colder environments and especially when the outer material is leather, for wet leather has a cold touch. The combination of membrane lining and seams will limit the breathability of the footwear, which will reduce the release of heat and humidity from the feet to the outside.

WO2007083124 describes a method to deposit a coating onto the surface of a piece of fashion clothing, clothing accessory (e.g. a shoe), and the like, by low pressure plasma polymerization. The technical problem solved here is protection against contamination from liquids, and odour resistance and colour fastness. The coating is deposited at the surface of the material to reduce the ingress of liquids in most normal circumstances. The document is silent on keeping the feet dry, and prevent them from cooling down. Furthermore, the document does not provide any indication on how outer surfaces, inner surfaces and internal surfaces can be provided with a water and/or oil repellent coating. In fact, the document does not disclose that the treated items may comprise inner surfaces, outer surfaces and internal surfaces. Further, the document does not disclose that an item of footwear needs to undergo a degassing prior to the coating process in order to obtain a coating on outer surfaces, inner surfaces and internal surfaces with excellent and uniform water- and/or oil repellent properties. Note hereby that pumping down a vacuum chamber filled with e.g. shoes, to base pressure does not in any way imply that a specific degassing level is reached for the shoe or the vacuum chamber prior to performing the plasma coating process. We refer to the examples later in the present document for evidence of the effects of degassing a shoe with inner, outer and internal surfaces prior to performing the plasma polymerization process.

WO2009056809 describes a method to reduce the water penetration over time during use. A protective coating is deposited on the surface of the footwear or constructed upper by means of low pressure plasma polymerization. The coating is said to be durable and waterproof, as to reduce the penetration of water over time during use, while breathability of the footwear is maintained. Although the water penetration is reduced, the document is silent on keeping the feet dry, and prevent them from cooling down. Furthermore, the document does not provide any indication on how outer surfaces, inner surfaces and internal surfaces can be provided with a water and/or oil repellent coating. In fact, the document does not disclose that the treated items may comprise inner surfaces, outer surfaces and internal surfaces. Further, the document does not disclose that an item of footwear needs to undergo a degassing prior to the coating process in order to obtain a coating on outer surfaces, inner surfaces and internal surfaces with excellent and uniform water- and/or oil repellent properties. Note hereby that pumping down a vacuum chamber filled with e.g. shoes, to base pressure does not in any way imply that a specific degassing level is reached for the shoe or the vacuum chamber prior to performing the plasma coating process. We refer to the examples later in the present document for evidence of the effects of degassing a shoe with inner, outer and internal surfaces prior to performing the plasma polymerization process.

WO2009010741 describes a method to provide an item of footwear with a liquid repellent coating by means of low pressure plasma polymerization. The coating is deposited on the complete item including fasteners, laces, zips, etc., in order to reduce the uptake of liquid during use, hereby reducing the weight gain of the footwear during use. The document is silent on breathability of the coated item of footwear, and on keeping the feet dry and on preventing cooling down of the feet. Furthermore, the document does not provide any indication on how outer surfaces, inner surfaces and internal surfaces can be provided with a water and/or oil repellent coating. In fact, the document does not disclose that the treated items may comprise inner surfaces, outer surfaces and internal surfaces. Further, the document does not disclose that an item of footwear needs to undergo a degassing prior to the coating process in order to obtain a coating on outer surfaces, inner surfaces and internal surfaces with excellent and uniform water- and/or oil repellent properties. Note hereby that pumping down a vacuum chamber filled with e.g. shoes, to base pressure does not in any way imply that a specific degassing level is reached for the shoe or the vacuum chamber prior to performing the plasma coating process. We refer to the examples later in the present document for evidence of the effects of degassing a shoe with inner, outer and internal surfaces prior to performing the plasma polymerization process.

Document GB 2454242 A discloses a method for maintaining the coefficient of friction of an item whilst enhancing its oil and/or water repellent properties, the method comprising forming an oil or water repellent coating or surface modification thereon by ionisation or activation technology. The item can undergo plasma polymerisation to form a polymeric layer on the surface thereon. The document does not provide any indication on how outer surfaces, inner surfaces and internal surfaces can be provided with a water and/or oil repellent coating. In fact, the document does not disclose that the treated items may comprise inner surfaces, outer surfaces and internal surfaces. Further, the document does not disclose that an item of footwear needs to undergo a degassing prior to the coating process in order to obtain a coating on outer surfaces, inner surfaces and internal surfaces with excellent and uniform water- and/or oil repellent properties. Note hereby that pumping down a vacuum chamber filled with e.g. shoes, to base pressure does not in any way imply that a specific degassing level is reached for the shoe or the vacuum chamber prior to performing the plasma coating process. We refer to the examples later in the present document for evidence of the effects of degassing a shoe with inner, outer and internal surfaces prior to performing the plasma polymerization process.

WO2009010738 describes a method to produce an item of footwear with a liquid repellent coating and a liquid absorbing foot supporting footbed. A liquid repellent coating is deposited on at least part of the surface of the item of footwear by means of low pressure plasma deposition. A liquid absorbing footbed or insole is placed inside the footwear after coating deposition to absorb the sweat which is then removed through outer fabric of the footwear. The document suggests that a hydrophilic inside and a hydrophobic outside is recommended for optimal wearer comfort. The technical problem solved here is how the feet can be kept dry from the inside out. However, the document is silent on reduction of weight gain, on keeping the feet dry from liquids from the outside, and on preventing them from cooling down due to humid outer fabric. More in particular, the method disclosed in this document does not prevent the fabric of the footwear itself to take up sweat from the wearer's foot, i.e. sweat from the foot can be absorbed by the fabric of the upper of the footwear item from the inside as the method of WO2009010738 does not seem to guarantee an essentially water- and/or oil-repellent coating on the inner surface of the item of footwear up until the tip of the item. Sweat is also absorbed by the liquid absorbing footbed or insole. The method of WO2009010738 also does not lead to coating of internal surfaces.

This uptake of sweat has a number of disadvantages, including the following:
The foot can be in contact with the wet fabric and wet insole during use. As the moisture is absorbed throughout the fabric, it is in close proximity to the outer surface and can cool down rapidly, giving rise to a wet and cold feeling for the wearer, which remains present for a long time due to the high thermal capacity of sweat. As a further result, excess sweat cannot be evaporated but is cooled down and remains as a cold liquid layer on the foot of the wearer.
The sweat vapour that penetrates the fabric from the inside towards the outside, may condensate and getting absorbed by the internal surfaces of the fabric. As the exterior of the fabric is coated, this coating will prevent the condensated sweat vapour from leaving the item of footwear. Consequently, the fabric may cool down rapidly, giving rise to a wet and cold feeling for the wearer.
Undesired odours remain longer present in the item of footwear, as the sweat in the fabric and especially in the insole is not easily vaporised;
The increase of weight by moisture is merely slowed down, but remains: whether the footwear gains weight from the uptake of water from the outside or from sweat uptake from the inside, the upper's fabric anyhow gets saturated with liquid at the internal surfaces, which can evaporate only very slowly.

Furthermore, a coating applied to an outer surface of the item of footwear is more prone to wear and tear.

Although the above prior art documents offer a solution to a single problem—namely or keeping the feet dry from liquids, water and moisture in the atmosphere, or reducing the weight gain of the shoe from the outside—all prior art documents fail to solve multiple technical problems in one solution. However, the end customer is looking for footwear which, during use, do not gain weight, keep the feet dry, and have an outer fabric which stays dry to prevent cooling down of the feet.

The present application improves on the foregoing prior art documents by providing a method which, surprisingly, solves these technical problems all together in a single method. This is not obvious over the prior art, since the prior art solutions for keeping the feet dry are limiting the breathability of the item of footwear, and the prior art solution for reduction of the weight gain do not offer a solution for keeping the feet dry since only the outer surface of the upper material of the item of footwear receives the coating. Combination of these two prior art solutions would lead to an item of footwear with limited breathability, which would not offer a solution for sweat generated on the inside. Further, since only the outer surface of the upper material of the item of footwear would be coated, water ingress is not maximally reduced, since the inside of the upper material is not protected against liquids.

The technical problems solved with the method according to the present invention are:
Keeping the feet dry from outer liquids, such as rain and snow and the like;
Maintaining the breathability of the item of footwear, and keeping the feet dry from sweat generated inside upon use;
Reduction of weight gain of the upper material due to uptake of liquid throughout the thickness of upper material of the footwear during use with resulting quick dry effect;
Preventing the feet from cooling down;
Ensuring that evaporated sweat does not condense on internal surfaces of the item of footwear, e.g. internal surfaces of a fabric, mesh or foam of the item of footwear, thereby preventing absorption of liquid sweat by the item of footwear and thus reducing weight gain.

### SUMMARY OF THE INVENTION

The present application solves the abovementioned technical problems by providing a method to selectively coat the footwear from the outside to the inside wherein the coating is deposited not only on the surface of the outer material—fabric, mesh, open foam, but also velour, leather and the like—but penetrates the structure of the outer material completely so that the coating is deposited on the internal surfaces of the material—e.g. the fabric material which is below the decorations and reinforcing plastic structures—and on the inside of the footwear as well, and whereby the characteristics of the coating, in particular the oil- and/or water repellency, is substantially uniform for inner, outer and internal surfaces. As a result, the coating obtained with methods of the present invention lasts longer than coatings obtained with prior art techniques.

### BRIEF DESCRIPTION OF THE FIGURES

FIG. 1 shows the front view of an example of a low pressure plasma equipment according to the present invention. This low pressure plasma system has a volume of 1836 litres and is designed to contain up to 40-60 pairs of footwear.

FIG. 2 illustrates the water contact angle in function of number of rubbing cycles.

FIG. 3 illustrates a weight comparison after submersion test.

FIG. 4 illustrates the drying time of foam structure after submersion.

FIG. 5 illustrates the drying time of faux fur (A4-sheet)

FIG. 6 shows water vapour permeability results

FIG. 7 shows air permeability results.

FIG. 8 shows, from left to right: untreated, plasma coated, conventionally coated.

FIG. 9 shows Footwear Shower Test results for 6 different types of sport shoes, uncoated and coated.

FIG. 10 shows the durability of the coating, by showing Footwear Shower Test results for 6 different types of sport shoes, up to 45 repetitions of the test.

FIG. 11 shows the durability of the coating, by showing Footwear Shower Test results for uncoated, coated, and coated+field tested footwear for running.

### DETAILED DESCRIPTION OF THE INVENTION

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, elements, members or steps, known in the art or disclosed therein.

The recitation of numerical ranges by endpoints includes all numbers and fractions subsumed within that range, as well as the recited endpoints.

The expression “% by weight” (weight percent), here and throughout the description unless otherwise defined, refers to the relative weight of the respective component based on the overall weight of the formulation.

“Footwear” or “item of footwear”, such as a “shoe”, as used herein describe a product which is to be worn at the feet. An item of footwear may comprise parts which are readily identified, such as a sole, an outsole, an insole, an upper, a fastener such as a loop-and-hook type fastener like Velcro® or a lace, decorations, stitches, reinforcements, etc. The parts are assembled in an item of footwear by different methods, including methods for permanent or semi-permanent assembly such as overmouling, gluing and stitching, or methods for releasable assembly, e.g. “lacing”. In the context of the present invention, an item of footwear may refer to the complete item of footwear—including fasteners, laces, outsole, insole, decorations, stitches, reinforcements, and the like—or, in case one or more areas are excluded from coating to parts or a subassembly of the complete item where this is clearly mentioned. In preferred embodiments of the present invention, the item of footwear comprises a component which is at least partly breathable, i.e. permeable to at least water vapour and/or evaporated sweat and preferably also to air, such as a fabric, mesh and/or foam, and/or the item of footwear comprises a component which is capable of absorbing liquid, in particular water or sweat, and/or which is permeable to liquid, in particular water or sweat. Non-limiting examples of such items of footwear are: sports shoes, sports shoes for water sports such as wet-suit footwear or wet suits comprising footwear, footwear for personal protective equipment, footwear for hiking, footwear for skiing and mountain climbing, fashion footwear, shoes, boots, sandals, closed shoes, open shoes, etc.

The term “inner surface”, as used herein, refers to the surface of the item of footwear on the inside, which is, can be or is intended to be in contact with a wearer's foot. The term “outer surface”, as used herein, refers to the surface of the item of footwear which is in direct contact with the outer environment. The term “internal surface” refers to surfaces which are not directly exposed to the wearer's foot or the outer environment. Examples of internal surfaces are surfaces in between fabric of the upper and decorations or reinforcements attached to the inner or outer surface of the upper, surfaces present within the fabric such as side surfaces of pores of the fabric or surfaces defined by open cells within the upper or sole, e.g. open cells of foam material which is processed in the construction of the item of footwear, for example to be used for the tongue of the item of footwear.

The terms “outgassing” and “degassing”, as used herein, are used interchangeably and refer to a process of removing gasses and liquids, more in particular within the context of this document, removing contaminants, gasses and liquids from items of footwear or parts thereof, in order to ensure a good adhesion between coating and at least part and preferably all, of the internal surface of the item.

The present invention solves the abovementioned technical problems by providing a method to selectively coat the footwear with a water- and/or oil-repellent coating from the outside to the inside wherein the coating is deposited not only on the surface of the outer material—fabric, mesh, open foam, but also velour, leather and the like—but penetrates the structure of the outer material so that the coating is deposited on the internal surfaces of the material and on the inside of the footwear as well. The water- and/or oil repellent coating is deposited by means of low pressure plasma polymerization.

Contrary to prior art which seem to guide towards a hydrophilic inside of the footwear for moisture regulation, e.g. by using a hydrophilic liquid absorbing insole, the present invention ensures sufficient breathability of the coated footwear material to exclude the need for a hydrophilic inside.

The advantage of selectively coating certain areas is that this allows to protect the footwear in an optimal way. The applicant discovered surprisingly that in some cases it is not needed, and sometimes even disadvantageous, to coat certain areas or components of the footwear.

The applicants have discovered that with a method according to the present invention it is possible to deposit a water and/or oil repellent coating throughout the complete upper material of the footwear, from the outside to the internal surfaces. The applicants have discovered surprisingly that this allows to deposit a coating on the upper material which is covered with decorative and/or functional plastic tapes and parts, for example for reinforcement of the ankles and the heel of the wearer, or for the logo or brand name of the footwear seller. This is an unexpected result of the present invention and method, since the decorative and/or functional plastic tapes cover some surface of the outer surface of the upper material of which the item of footwear is made so that this covered surface is not directly exposed to the plasma.

Consequently, the advantage of the method according to the present invention is that not only the surface of the upper fabric which is directly exposed to the plasma is coated, but that also the upper material which is shielded from direct exposure to the plasma will be coated. This is a clear improvement over the prior art, and contributes highly to a reduction of the water ingress and thus weight gain over time during use and quick drying effect, since in case the coating on the outer surface would get damaged, the internal and inner surfaces are still coated and preventing the uptake of liquids through capillary effects. Further, coated internal and inner surfaces also exclude the use of the prior art liquid repellent membranes, so that by the method of the present invention the breathability of the item of footwear is maintained as well.

It is a first aspect of the present invention to provide a method to obtain a water and/or oil repellent coating on footwear to keep the feet dry while at the same time reducing the weight gain of the material of which the item of footwear is made, reducing the drying time (so-called “quick dry effect”), and maintaining the breathability of the material, whereby the coating is selectively deposited by means of low pressure plasma polymerization.

It is a second aspect of the present invention to provide a method to obtain a water and/or oil repellent coating on footwear to keep the feet dry while at the same time reducing the weight gain of the material of which the item of footwear is made, reducing the drying time (so-called “quick dry effect”), and maintaining the breathability of the material, whereby the coating is deposited throughout the material from the outside of the material to the internal surfaces of the material by means of low pressure plasma polymerization so that also the upper material of the footwear covered by decorative and/or functional plastic tapes receives the low pressure plasma coating for improved protection against the ingress of liquids.

It is a third aspect of the present invention to provide an item of footwear with a water and/or oil repellent coating which keeps the feet dry while at the same time reducing the weight gain of the material of which the item of footwear is made, reducing the drying time (so-called “quick dry effect”), and maintaining the breathability of the material, whereby the coating is deposited selectively and throughout the material from the outside to the internal surfaces of the material by means of low pressure plasma polymerization so that also the upper material of the footwear covered by decorative and/or functional plastic tapes receives the low pressure plasma coating for improved protection against the ingress of liquids.

It is a fourth aspect of the present invention to provide a water and/or oil repellent coating which is deposited selectively and throughout the material from the outside to the internal surfaces of the material by means of low pressure plasma polymerization so that also the upper material of the footwear covered by decorative and/or functional plastic tapes receives the low pressure plasma coating for improved protection against the ingress of liquids, whereby the coating reduces the weight gain of the material of which the item of footwear is made, reduces the drying time (so-called “quick dry effect”) of the footwear, and maintains the breathability of the material and keeps the feet dry.

The applicants have discovered that in order to obtain optimal protection in terms of keeping the feet dry, reducing the water uptake of the footwear material for reduced weight gain, reduced drying time, and no cooling down of the feet due to humid material, it is advantageous that the coating is deposited selectively. Selective coating may be done by preventing deposition of the coating on one or more areas or components, or by removing one or more components from the item of footwear prior to coating. The removed components may receive a coating in a separate process for optimal results, or may not be coated when there is no benefit or even a negative influence on the performance when said components are coated.

The applicants have further developed a method whereby the coating is deposited throughout the material of which the footwear is made, from the outside towards the inside, instead of coating the outer surface—like it is done in prior art documents. The applicants have discovered surprisingly that by coating not only the outer surface of the footwear material, but the inner surfaces as well, the breathability of the material is not influenced, while at the same time the weight gain during use and the drying time after use is further reduced (so-called “quick dry effect”) and the footwear material is protected against becoming wet, which keeps the feet dry and warm—a wet or humid footwear material may lead to cold feet. Further, the coating method according to the present invention allows to deposit a coating also on the upper material of the footwear covered by covering elements, such as decorative and/or functional plastic tapes, stitches, prints, printing of the brand name, receives the low pressure plasma coating for improved protection against the ingress of liquids.

In a first embodiment according to the present invention, the selective coating is done by coating the items of footwear without laces or other type of fasteners so that not the entire item of footwear receives the coating in the same processing step. In manufacturing, this may be done either by performing the coating step on the subassembly of the item of footwear without fasteners or laces prior to the processing step whereby the fasteners and laces are placed on the footwear. Alternatively, this may be realized by removing the fasteners or laces prior to performing the low pressure plasma polymerization process.

Preferably, when using laces, the laces are coated in a separate process, e.g. in a different processing chamber design to contain many laces for a high throughput. The applicants have discovered surprisingly that the optimal process to coat the laces and to coat the item of footwear (without laces) may be different, since the materials used have a different structure. Laces tend to be strong and circular in cross-section. Further, the applicants have surprisingly discovered that when the laces are coated separately, the openings in the shoe where the laces are placed into, and the surrounding material, such as the tongue, may be accessed more easily by the plasma and will thus be coated in a better, more uniform way.

Whether fasteners other than laces are coated in a separate process or not, depend on the type of fasteners.

The applicants have surprisingly discovered that for fasteners of the hook-and-loop type, there is no advantage in applying a coating. When fasteners of the hook-and-loop type are exposed to the plasma and have a liquid repellent coating, the sticking effect of the fasteners is reduced, which leads to items of footwear which are more difficult to be closed and are less comfortable to wear.

Preferably, a selective coating method according to the present invention may prevent deposition of a water- and/or oil repellent nanocoating on fasteners of the hook-and-loop type by deposition of the coating on the subassembly of the item of footwear, before the hook-and-loop fasteners are stitched onto the upper material of the footwear.

Alternatively, a selective coating method according to the present invention may prevent deposition of a water- and/or oil repellent nanocoating on fasteners of the hook-and-loop type by deposition of the coating on the item of footwear whereby the hook-and-loop fasteners are shielded from the plasma.

Preferably, the shielding of the hook-and-loop fasteners is done with a non-textile material that allows perfect shielding from exposure to the plasma. Preferably, a flexible plastic tape, or another type of adhesive tape, or paper may be used to prevent the fasteners from receiving a water and/or oil repellent nanocoating.

In a second embodiment of the present invention, the selective coating is done by coating the items of footwear whereby the outsole of the item of footwear is shielded to prevent it from receiving the coating.

Preferably, this may be done in the manufacturing process by coating the upper textile material of the item of footwear before the outsole is connected or moulded to the upper textile material.

Alternatively, this may be done by covering the outsole of the footwear prior to coating polymerization, for example by putting the shoe in a specially designed tray to contain the shoes in the plasma chamber, whereby the tray is designed as to prevent exposure of the outsole to the plasma. Alternatively, this may be done by placing a shielding material, e.g. a tape or plastic structure, onto the outsole to prevent exposure to the plasma.

The applicants have surprisingly discovered that it is advantageous not to coat the outsole of an item of footwear, since the coatings used in the present invention tend to be low friction coatings. In case the outsole of the item of footwear would be coated, the low friction coating may lead to slippery shoes, which may be dangerous in some situations, e.g. on smooth floors.

In a third embodiment according to the present invention, the coating is deposited throughout the material of which the upper of the footwear is made, from the outside to the inside, so that the coating is present not only at the outer surface of the material, but also at the internal surfaces and the inside of the item of footwear.

The applicants have surprisingly discovered that in this way a nanocoating is deposited also on the upper material of the footwear which is covered by the decorative and/or functional plastic tape, e.g. at areas where reinforcement is needed for improved wearer comfort, such as the ankles.

Preferably, the upper fabric or material of which the item of footwear is made, has a nanocoating not only at the outer surface of said fabric or material, but also throughout the complete upper material.

Consequently, this contributes highly to a reduction of the water ingress, thus weight gain over time during use and drying time of the footwear after use (so-called “quick dry effect”), since in case the coating on the outer surface would get damaged, the internal and inner surfaces are still coated and preventing the uptake of liquids through capillary effects. Further, coated internal and inner surfaces also exclude the use of the prior art liquid repellent membranes, so that by the method of the present invention the breathability of the item of footwear is maintained as well. Consequently, this keeps the feet dry as well, and since the material of the footwear won't become humid or wet, this will not lead to cold feet, hence increased wearer comfort.

Further, the applicants have surprisingly discovered that coating the material of which the item of footwear is made, throughout its structure, so that a coating is deposited into the core, onto the internal surfaces, has no negative impact on the breathability of the item of footwear, contrary to membranes which keep the feet dry but have limited breathability.

The thickness of the nanocoating is in the range of nanometres, typically from 10 to 1000 nm, which is less than the average size of openings in a woven, knitted or even non-woven fabric, mesh or 3D-foam structure used to produce the item of footwear. The deposited coating covers the individual fibres and yarns without blocking the openings in the fabric, mesh or foam.

The water and/or oil repellent protective nanocoating is deposited selectively and into the core of the material of which the item of footwear is made, by means of a low pressure plasma polymerization process.

The present invention concerns a low-pressure plasma polymerization coating apparatus for high-load coating of items of footwear. Such a low-pressure plasma polymerization coating apparatus comprises a vacuum chamber in which the plasma polymerization coating process can take place.

More in particular, the present invention concerns a low-pressure plasma polymerization coating apparatus for high-load coating of items of footwear which comprises at least two pairs of electrodes, each pair comprising a ground electrode and a radiofrequency (RF) electrode for inducing a plasma and for applying a plasma polymerized coating onto items of footwear which can be placed in between the ground electrode and the RF electrode of each pair, whereby the distance between the ground electrode of the first electrode pair and the RF electrode of the second pair is larger than 1 mm and smaller than 50 mm. The distance between the two electrodes of the same pair is preferably larger than 50 mm, more preferably larger than 100 mm, and preferably smaller than 500 mm, more preferably smaller than 250 mm.

The present invention also concerns a low-pressure plasma polymerization coating apparatus for high-load coating of items of footwear, said apparatus being configured to perform a method as disclosed in this document, preferably an apparatus comprising at least two pairs of electrodes as discussed here above or further in this document.

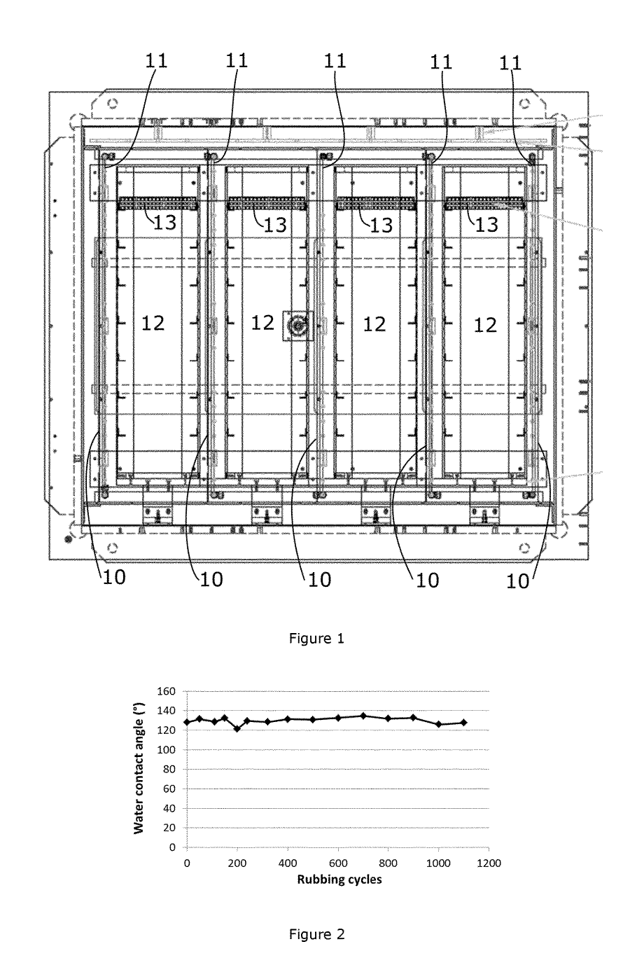

FIG. 1 shows an embodiment of a low pressure plasma equipment according to the present invention, wherein a method according to the present invention can be carried out. The plasma chamber has a volume of 1836 L, and has radiofrequency electrodes 10 and ground electrodes 11 which are positioned in a vertical way that generates a favourable plasma in the wider spaces, so-called “slots” 12 between the electrodes.

Preferably, at least one radiofrequency electrode 10 and one ground electrode 11 of an adjacent pair of electrodes, are positioned close to each other, having a distance of from 1 mm to 50 mm, such as 2 mm to 40 mm, such as 5 mm to 30 mm, for example 30, 29, 28, 27, 26, 25, 24, 23, 22, 21, 20, 19, 18, 17, 16, 15, 14, 13, 12, 11, 10, 9, 8, 7, 6 or 5 mm.

Preferably, the distance between the ground electrode and the RF electrode of a pair of electrodes, marks a wider space or so-called “slot”, and is from 50 mm to 500 mm, such as 100 mm to 450 mm, such as 120 mm to 400 mm, for example 400, 390, 380, 375, 370, 360, 350, 340, 330, 325, 320, 310, 300, 290, 280, 275, 270, 260, 250, 240, 230, 225, 220, 210, 200, 190, 180, 175, 170, 160, 150, 140, 130, 125 or 120 mm.

The applicants discovered that by placing pairs of electrodes, each consisting of one radiofrequency electrode 10 and one ground electrode 11 inside the plasma chamber, a favourable, stable and uniform plasma is generated in the slots.

By using this electrode configuration according to the present invention, the applicants have discovered that the deposited coating on the items of footwear, preferably without the laces and with the outsole covered not to receive the plasma coating—for reasons of the aforementioned advantages and benefits—is more uniform than when a prior art set-up of single electrodes on each side of a slot is used.

Preferably, the apparatus comprises slots in between the electrodes of each pair, said slots preferably comprising means for placing one or more sample holders at variable or different positions, e.g. at variable or different heights. As such, the apparatus can be configured to coat a great variety of types of items of footwear, such as high boots or low sandals. More preferably, said apparatus comprises one or more sample holders inserted in said slots for holding the items of footwear or parts of the item of footwear, which are to be coated.

In the slots 12, it is possible to place sample holders 13 horizontally, such as perforated trays or containers, which may contain the items of footwear, preferably without the laces and with the outsole covered not to receive the plasma coating—for reasons of the aforementioned advantages and benefits—to be coated. Preferably, perforated trays are used.

The plasma chamber in FIG. 1 has 4 slots 12, and each slot may contain up to 8 trays 13, and each tray may contain up to 4 items of footwear (2 pairs), preferably without the laces and with the outsole covered not to receive the plasma coating—for reasons of the aforementioned advantages and benefits—, giving a capacity of 64 pairs of said items of footwear.

Preferably, a frame or another construction to keep the trays 13 in place is placed into the plasma chamber to allow easy loading and unloading of the plasma chamber before and after each processing run.

Preferably, the numbers of trays 13 within each slot 12 may be varied according to the type of footwear to be coated. For example, summer shoes tend to have limited height, and up to 8 trays may be used. When the height of the footwear, preferably without the laces and with the outsole covered not to receive the plasma coating—for reasons of the aforementioned advantages and benefits—exceeds the distance between two trays 13, the plasma chamber according to the present invention allows to leave out one or more trays per slot 12. Consequently, number of said footwear that may be coated in a single batch, will decrease. For example, when 6 instead of 8 trays are used per slot, the capacity is (placing 2 pairs of said footwear per tray) 48 pairs of said footwear. In most production environments, this is still enough to implement the plasma chamber in the manufacturing line.

Since footwear may contain considerably amounts of fabric, plastics and/or adhesives such as glue, footwear may contain considerable amounts of moisture and humidity when placed inside the plasma chamber. This may have a negative impact on the coating performance after coating, but also on the cycle time. Therefore, the applicants have discovered that an outgassing may be advantageous, especially in case large volumes of footwear, preferably without the laces and with the outsole covered not to receive the plasma coating—for reasons of the aforementioned advantages and benefits—are to be treated, e.g. in mass production.

Further, the applicants have surprisingly discovered that an outgassing allows better penetration of the plasma polymerization coating into the core of the material of which the items of footwear is made. This is because the outgassing removes not only contaminants and moisture from the surface, but also from the internal surfaces, which is not the case without outgassing. When the moisture from the internal surfaces is removed properly, these internal surfaces become accessible by the coating process of the present invention. Consequently, the performance of the deposited coatings—in terms of water and/or oil repellency, dry feet, reduced weight gain during use, quick dry effect and breathability—will be enhanced when using a degassing prior to coating deposition.

Therefore, the present invention relates to a method for coating outer, internal and inner surfaces of an item of footwear by a low-pressure plasma polymerization coating process, said item comprising an upper with covering elements which are applied to an outer surface of the upper, by degassing the item of footwear prior to said coating process.

In an embodiment, said item of footwear is degassed to a degassing level of at most 50 mTorr, more preferably at most 20 mTorr, even more preferably at most 10 mTorr. Additionally or alternatively, said item of footwear is degassed in a vacuum chamber until said vacuum chamber comprises a degassing level of at most 100 mTorr, more preferably at most 50 mTorr, such as 40 mTorr or less. Note that the degassing level of the vacuum chamber may depend on the load, i.c. on the number and nature of the items of footwear placed inside the chamber.

In order to determine the degassing level of an item of footwear, the pressure increase in a vacuum chamber due to gasses released from the item of footwear needs to be determined. Thereto, the item is positioned in a vacuum chamber, e.g. a plasma chamber, which is pumped down to a degassing pressure P_{degassing}, which is less than 500 mTorr, preferably less than 250 mTorr, such as less than 100 mTorr, and next the inlets and outlets of the vacuum chamber are closed off. After a preset time of 60 seconds, the pressure increase, ΔP, inside the chamber is measured. The degassing level of the item is then given by the pressure increase, ΔP, minus the whistling leak pressure of the vacuum chamber at the degassing pressure P_{degassing}. Optionally, if more than one item of footwear is positioned inside the vacuum chamber, the degassing level of an item of footwear is given by the pressure increase, ΔP, minus the whistling leak pressure of the vacuum chamber at the degassing pressure P_{degassing}, divided by the number of items of footwear in the vacuum chamber. Hereby, the whistling leak pressure of the vacuum chamber at the degassing pressure P_{degassing} is determined by repeating the same procedure for an empty chamber with all items of footwear removed from the vacuum chamber—pumping down to the same degassing pressure P_{degassing}, closing off all inlets and outlets of the vacuum chamber and measuring the pressure increase after the same preset time as for the loaded chamber, i.e. 60 seconds.

In order to determine the degassing level of a vacuum chamber which is loaded with a number of items of footwear, the pressure increase in the vacuum chamber due to gasses released from the items of footwear needs to be determined. Thereto, the items of footwear are positioned in a vacuum chamber, e.g. a plasma chamber, which is pumped down to a degassing pressure P_{degassing}, which is less than 500 mTorr, preferably less than 250 mTorr, such as less than 100 mTorr, and next the inlets and outlets of the vacuum chamber are closed off. After a preset time of 60 seconds, the pressure increase, ΔP, inside the chamber is measured. The degassing level of the chamber is then given by the pressure increase, ΔP, minus the whistling leak pressure of the vacuum chamber at the degassing pressure P_{degassing}. Hereby, the whistling leak pressure of the vacuum chamber at the degassing pressure P_{degassing} is determined by repeating the same procedure for an empty chamber with all items of footwear removed from the vacuum chamber—pumping down to the same degassing pressure P_{degassing}, closing off all inlets and outlets of the vacuum chamber and measuring the pressure increase after the same preset time as for the loaded chamber, i.e. 60 seconds.

In a preferred embodiment, the method of the present invention involves the step of measuring the degassing level of the vacuum chamber prior to said coating process. This allows to check if an appropriate degassing level, in particular if a degassing level of the vacuum chamber of at most 50 mTorr, is reached in order to see if one may continue with the coating step or if further degassing is to be performed. Furthermore, by measuring the degassing level prior to the coating process, it becomes possible to calibrate the degassing process for subsequent batches of similar loads, e.g. by measuring the degassing level after performing the degassing step for a number of durations, in order to check which duration is required to obtain the appropriate degassing level. Such calibration allows optimizing the degassing step, in particular it allows to find, for specific batches of items of footwear and for a specific vacuum chamber, the minimal duration for which the degassing needs to be performed in order to obtain the appropriate degassing level of the chamber, e.g. at most 50 mTorr.

In a preferred embodiment, the low pressure plasma polymerization is preceded by a low pressure plasma pre-treatment step, preferably the degassing and the pre-treatment being combined in a single processing step.

In an embodiment, said method comprises shielding parts of the item prior to said coating process, removing of parts of the item prior to said coating process, and/or separately coating parts of the item by said coating process prior to assembly of the parts into said item.

In an embodiment, the low pressure plasma polymerization uses a monomer which is

CᵤF₂ᵤ₊₁C_{w}X_{2w}CR₁₃Y—OCO—C(R₁₄)═CH₂,

wherein u is 2 to 6, w is 0 to 9, X and Y are H, F, Cl, Br or I, R₁₃ is H or alkyl or a substituted alkyl, e.g. an at least partially halo-substituted alkyl, and R₁₄ is H or alkyl or a substituted alkyl, e.g. an at least partially halo-substituted alkyl.

In another embodiment, the low pressure plasma polymerization uses a monomer which is an organosilane, wherein the organosilane is:
Y₁—X—Y₂ wherein X is O or NH, Y₁ is —Si(Y₃)(Y₄)Y₅ and Y₂ is Si(Y_{3′})(Y_{4′})Y_{5′} wherein Y₃, Y₄, Y₅, Y_{3′}, Y_{4′}, and Y_{5′} are each independently H or an alkyl group of up to 10 carbon atoms; wherein at most one of Y₃, Y₄ and Y₅ is hydrogen, at most one of Y_{3′}, Y_{4′} and Y_{5′} is hydrogen; and the total number of carbon atoms is not more than 20;
cyclic according to —[Si(CH₃)_{q}(H)_{2-q}—X—]ₙ— where n is 2 to 10, wherein q is 0 to 2 and wherein the total number of carbon atoms is not more than 20;
CH₂═C(R₁)—Si(R₂)(R₃)—R₄ wherein R₁ is H or an alkyl group, e.g. —CH₃, and wherein R₂, R₃ and R₄ are each independently H, an alkyl group of up to 10 carbon atoms or an alkoxy group —O—Z, wherein Z is preferably —CₜH₂ₜ₊₁, wherein t is 1 to 10;
R₅—Si(R₆)(R₇)—R₈ wherein R₅ is H or an alkyl group, e.g. —CH₃, and wherein R₆, R₇ and R₈ are each independently H, an alkyl group of up to 10 carbon atoms or an alkoxy group —O—Z, wherein Z is preferably —CₜH₂ₜ₊₁, wherein t is 1 to 10; or
—CH₂═C(R₉)C(O)—O—(CH₂)ₚ—Si(R₁₀)(R₁₁)—R₁₂ wherein R₉ is H or an alkyl group, e.g. —CH₃, wherein p is from 0 to 10, and wherein R₁₀, R₁₁ and R₁₂ are each independently H, an alkyl group of up to 10 carbon atoms or an alkoxy group —O—Z, wherein Z is preferably —CₜH₂ₜ₊₁, wherein t is 1 to 10.

In a further aspect, the present invention concerns the use of a method for coating, preferably selectively coating, an item of footwear as disclosed herein, to increase security and/or comfort of the wearer of an item of footwear obtained by said method.

In yet a further aspect, the present invention concerns the use of a method as disclosed in this document, to reduce the weight gain of an item of footwear during use, to prevent the item of footwear from absorbing liquid so as to lead to a warm and dry feeling of the wearer's feet, and to shorten the drying time of the item of footwear. Preferably, the drying time—the time needed to have a weight increase of maximum 5% compared to the initial weight of the item of footwear before wearing it—is reduced to an absolute minimum.

In yet a further aspect, the present invention concerns a degassed item of footwear. In an embodiment, said item comprises an upper with covering elements which are applied to an outer surface of the upper.

Preferably, said degassed item of footwear comprises a degassing level of less than 50 mTorr, more preferably less than 20 mTorr, even more preferably less than 10 mTorr, and/or said item of footwear is located in a vacuum chamber, loaded with a number of items of footwear, said vacuum chamber comprising a degassing level of at most 100 mTorr, preferably at most 50 mTorr, more preferably at most 40 mTorr. For a fully loaded chamber, e.g. 50 pairs of footwear, the chamber with the full load is preferably degassed to a degassing level of less than 100 mTorr, more preferably less than 50 mTorr, such as less than 40 mTorr.

In an embodiment, said degassing is performed in a degassing apparatus or degassing chamber which is different from a plasma chamber in which the low-pressure plasma polymerization coating process is performed. Such a degassing apparatus or degassing chamber may comprise a heating element and may be an oven.

The present invention also concerns an item of footwear comprising a water- and/or oil-repellent coating on the outer surface of an upper of the item of footwear, as well as on internal surfaces and inner surfaces of the item of footwear, preferably said coating applied by a method according to the present invention.

In order to determine whether internal surfaces of the treated item of footwear are coated with a water- and/or oil-repellent coating, the item of footwear can be cut open, after which the internal surfaces along the cut are exposed and can be tested for their oil- and/or water-repellency. In preferred embodiments, the coating on the internal surface comprises an oil-repellency level which is at least level 1 according to oil repellency test ISO 14419, and preferably which is maximally one level below the water- and/or oil-repellency level of the inner and/or outer surface coating, e.g. if the inner and outer surface coating have an oil or water repellency level of 5, the internal surface coating preferably has an oil or water repellency level of at least 4, such as 4, 5, 6, etc.

The present invention also concerns an item of footwear comprising a water- and/or oil-repellent coating applied by a low-pressure plasma polymerization coating process, said item of footwear comprising a Drying Time which is at most 50%, preferably at most 40%, more preferably at most 30%, still more preferably at most 20%, yet most preferably at most 10%, such as 9%, 8%, 7%, 6%, 5%, 4%, 3%, 2%, 1% and most preferably 0%, of a Drying Time of the item of footwear when uncoated, preferably said coating applied by a method according to the present invention. The Drying Time is defined as the time needed for an used/tested item of footwear to reach a weight gain of 5% or lower, wherein the weight gain is the increase of weight of the item of footwear compared to the dry weight of the same item of footwear before using/testing.

The present invention also concerns an item of footwear comprising a water- and/or oil-repellent coating applied by a low-pressure plasma polymerization coating method applied according to the present invention, said item of footwear comprising a Direct Weight Gain which is at most 50%, preferably at most 40%, more preferably at most 30%, still more preferably at most 20%, yet most preferably at most 10%, such as 9%, 8%, 7%, 6%, 5%, 4% or less, of a Direct Weight Gain of the item of footwear when uncoated. The Direct Weight Gain is the weight increase of an item of footwear right after using/testing, compared to the dry weight of the same item of footwear before using/testing.

The Direct Weight Gain and the Drying Time are determined after a test that simulates the daily use of the item of footwear. This test is carried out as following:
Weigh the item of footwear prior to submersion (dry weight);
Put the item of footwear at the foot to simulate actual use of the item of footwear;
Soak the foot with the item of footwear for 60 seconds horizontally in a vessel filled with water at room temperature (23±2° C.) up to the height where the foot and leg come out of the item of footwear;
Take the foot with the item of footwear out of the vessel, and take the footwear off from the foot;
Shake out the item of footwear by hand 20 times (up-down movement);
Weight again the item of footwear (tested item of footwear).

The different in weight between the tested item of footwear and the dry item of footwear (weight before simulation of use test), is the Direct Weight Gain, expressed in grams. The Direct Weight Gain expressed in % is the Direct Weight Gain in grams divided by the dry weight of the item of footwear multiplied by 100.

Now, the item of footwear is hung semi-horizontally with opening for the feet oriented downwards to allow drying. Every 5 minutes, the item of footwear is weighted again, until the weight increase (actual weight minus the dry weight before submersion) is 5% or less of the dry weight of the item of footwear. When this is reached, the required time to reach this is referred to as the Drying Time.

The present invention also concerns an item of footwear comprising a water- and/or oil-repellent coating applied by a low-pressure plasma polymerization coating process, said item of footwear comprising a Shower Drying Time which is at most 25%, preferably at most 20%, more preferably at most 15%, still more preferably at most 10%, such as 10%, 9%, 8%, 7%, 6%, 5%, 4%, 3%, 2%, 1% and most preferably 0%, of a Shower Drying Time of the item of footwear when uncoated, preferably said coating applied by a method according to the present invention. The Shower Drying Time is defined as the time needed for an used/tested item of footwear to reach a weight gain of 3% or lower, wherein the weight gain is the increase of weight of the item of footwear compared to the dry weight of the same item of footwear before using/testing.

The present invention also concerns an item of footwear comprising a water- and/or oil-repellent coating applied by a low-pressure plasma polymerization coating method applied according to the present invention, said item of footwear comprising a Shower Direct Weight Gain which is at most 25%, preferably at most 20%, more preferably at most 15%, such as 15%, 14%, 13%, 12%, 11%, 10%, 9%, 8%, 7%, 6%, 5%, 4%, 3%, 2%, 1% or less, of a Shower Direct Weight Gain of the item of footwear when uncoated. The Shower Direct Weight Gain is the weight increase of an item of footwear right after using/testing, compared to the dry weight of the same item of footwear before using/testing.

The Shower Direct Weight Gain and the Shower Drying Time are determined after a test that simulates the daily use of the item of footwear, the so-called “Footwear Shower Test”. This test is carried out as follows:
Weigh the item of footwear prior to submersion to obtain the dry weight in grams;
Put a hydrophobic coated sock on a plastic foot mold;
Place the sock-mold combination in the footwear;
If fasteners such as laces or hook-and-loop fasteners, are present, close the fasteners firmly;
Place the footwear with mold and sock in the vessel for the Footwear Shower Test;
Spray 500 ml water onto the footwear, over a duration of 60 seconds;
Allow footwear to drip out for 10 seconds by placing upside down;
Take out sock-mold combination;
Pour ingressed but not absorbed water out in a swift movement;
Weigh the tested item of footwear to obtain the final weight in grams.

The different in weight between the tested item of footwear, i.e. the final weight, and the dry item of footwear, i.e. the dry weight, is the Shower Direct Weight Gain, expressed in grams. The Shower Direct Weight Gain expressed in % is the Shower Direct Weight Gain in grams divided by the dry weight of the item of footwear, multiplied by 100.

Now, the item of footwear is hung vertically with opening for the feet oriented downwards to allow drying. Every 5 minutes, the item of footwear is weighted again, until the weight gain of the tested footwear (actual weight minus the dry weight before submersion, both in grams, divided by the dry weight of the item of footwear in grams, multiplied by 100) is 3% or less. When this is reached, the required time to reach this is referred to as the Shower Drying Time.

The size of the effect of outgassing may depend on the amount of said footwear in the plasma chamber, as well as the design of said footwear and the materials of which said footwear is constructed.

Preferably, an outgassing is performed prior to starting the first process step.

Optionally, but preferably, a low pressure plasma pre-treatment is carried out before the coating polymerization step, and after the outgassing step when an outgassing step is performed. A pre-treatment step in the form of an activation and/or cleaning and/or etching step might be advantageous for improving the adhesion and cross-linking of the polymer coating and for obtaining better penetration into the core of the footwear materials to coat not only the outer surface of the materials, but the internal surfaces as well.

Further, the applicants have surprisingly discovered that a pre-treatment allows better penetration of the plasma polymerization coating into the core of the material of which the items of footwear is made, so that also the upper material which is covered by decorative and/or functional plastic parts and tapes become coated. This is because the pre-treatment removes not only contaminants from the surface, but also from the internal surfaces, which is not the case without pre-treatment. The resulting low pressure plasma coating is more uniform, and thanks to a selective coating process and coating into the core of the footwear materials, an optimal performance in terms of dry outer fabric, reduced weight gain and drying time (so-called “quick dry effect”), and dry feet is obtained. This is not possible without the outgassing and/or the plasma pre-treatment of the present invention.

Preferably, the outgassing prior to the first processing step—the coating step or a pre-treatment step—is performed by pumping the plasma chamber down to a set low pressure, which may be equal to or higher than the set base pressure of the first processing step. Next, the pumping down is continued for a set time, after which the pumping is stopped and all chamber inlets and outlets are closed for a set outgassing time, and the pressure increase over that outgassing time is measured. When the pressure increase is below a set value—a maximum pressure increase—, the outgassing is considered considerable low to continue the process. When the pressure increase is higher than the set value, there is still outgassing, and the same outgassing sequence is repeated, until the pressure increase is below the set value.

The set parameters of the outgassing, such as set low pressure, set pumping down time, set outgassing time and set maximum pressure increase, depend on the plasma equipment used and the volume of the plasma chamber, the type of pump used, the number of items of footwear, preferably without the laces and with the outsole covered not to receive the plasma coating—for reasons of the aforementioned advantages and benefits—and the design and material of said footwear.

Preferably, the set low pressure is from 5 mTorr to 200 mTorr, more preferably from 10 mTorr to 150 mTorr, such as 15 mTorr to 125 mTorr, for example 125, 120, 110, 100, 90, 80, 75, 70, 60, 50, 40, 30, 25, 20, or 15 mTorr.

Preferably, the set pumping down time is from 10 s to 900 s, more preferably from 30 s to 840 s, even more preferably from 45 s to 780 s, such as 60 s to 720 s, for example 720, 690, 660, 630, 600, 570, 540, 510, 480, 450, 420, 390, 360, 330, 300, 270, 240, 210, 180, 150, 120, 90, or 60 s.

Preferably, the outgassing time is from 1 s to 120 s, more preferably 5 s to 90 s, such as 90, 80, 75, 70, 60, 55, 50, 45, 40, 35, 30, 25, 20, 15, 10, or 5 s.

Preferably, the maximum pressure increase is from 10 mTorr to 500 mTorr, more preferably from 15 mTorr to 250 mTorr, such as 20 mTorr to 100 mTorr, for example 100, 90, 80, 75, 70, 60, 50, 40, 30, 25 or 20 mTorr.

When a pre-treatment is carried out, it is preferably carried out using inert gases, such as Ar, N₂ or He, additionally or alternatively combined with reactive gases, such as H₂, or O₂, or with etching reagents such as CF₄. Mixtures of the foregoing gases can also be used.

More preferably the pre-treatment is done Ar or He.

Preferably, the pre-treatment is performed from 30 seconds to 30 minutes, for example from 45 seconds to 15 minutes, preferably 1 minute to 10 minutes, e.g. 9, 8, 7, 6, 5, 4, 3, 2, or 1 minutes. The duration of the pre-treatment depends on the precursor monomer used and on the design and materials used to produce the items of footwear to be treated, preferably without the laces and with the outsole covered not to receive the plasma coating—for reasons of the aforementioned advantages and benefits.

The power used in the pre-treatment can be applied in continuous wave mode or in pulsed wave mode.

Preferably, when applied in continuous wave mode in a 1836 litre plasma chamber, the pre-treatment takes place at powers of 5 to 5000 W, more preferably 25 to 4000 W, even more preferably at 50 to 3000 W, say 75 to 2500 W, such as 100 to 2000 W, e.g. 2000, 1900, 1800, 1750, 1700, 1600, 1500, 1400, 1300, 1250, 1200, 1100, 1000, 950, 900, 850, 800, 750, 700, 650, 600, 550, 500, 450, 400, 350, 300, 250, 200, 175, 150, 125, or 100 W.

Preferably, when applied in pulsed wave mode in a 1836 litre plasma chamber, the pre-treatment takes place at a power of 5 to 5000 W, more preferably 25 to 4000 W, even more preferably at 50 to 3000 W, say 75 to 2500 W, such as 100 to 2000 W, e.g. 2000, 1900, 1800, 1750, 1700, 1600, 1500, 1400, 1300, 1250, 1200, 1100, 1000, 950, 900, 850, 800, 750, 700, 650, 600, 550, 500, 450, 400, 350, 300, 250, 200, 175, 150, 125, or 100 W.

When applied in pulsed power mode, the pulse frequency may be from 100 Hz to 10 kHz having a duty cycle from approximately 0.05 to 50%, with the optimum parameters being dependent on the gas or gas mixture used.

Preferably, in a 1836 litre plasma chamber, the operating pressure for the pre-treatment is 10 to 500 mTorr, more preferably 15 to 250 mTorr, even more preferably 20 to 200 mTorr, say 25 to 175 mTorr, such as 30 to 150 mTorr, e.g. 150, 140, 130, 125, 120, 110, 100, 95, 90, 85, 80, 75, 70, 65, 60, 55, 50, 45, 40, 35, or 30 mTorr.

For systems of other dimensions, with another volume and/or electrode set-up, the power value, the operating pressure and the pre-treatment time are varied in a way that the best process parameters for the pre-treatment are used.

Preferably, when the items of footwear, preferably without the laces and with the outsole covered not to receive the plasma coating—for reasons of the aforementioned advantages and benefits—as placed in the plasma chamber, contain low amounts of moisture and humidity, the outgassing step and the pre-treatment may be combined in a single processing step, whereby the outgassing takes place during the pre-treatment. This may be done for example when said footwear has been dried prior to being placed in the plasma chamber.

After the outgassing and/or the pre-treatment step, a plasma polymerization step is performed, during which the nanocoating is deposited selectively on the footwear, and further into the core of the material of which the item of footwear is made.

In an embodiment according to the present invention, the low pressure plasma polymerization as described above—selective and into the core of the material of which the item of footwear is made—is a low pressure plasma polymerization of an acrylate or methacrylate precursor monomer, said (meth)acrylate being of the formula (I):

CᵤF₂ᵤ₊₁C_{w}X_{2w}CR₁₃Y—OCO—C(R₁₄)═CH₂ (I)

wherein u is 2 to 6, w is 0 to 9, X and Y are H, F, Cl, Br or I, R₁₃ is H or alkyl or a substituted alkyl, e.g. an at least partially halo-substituted alkyl, and R₁₄ is H or alkyl or a substituted alkyl, e.g. an at least partially halo-substituted alkyl.

Preferably, the acrylate or methacrylate is introduced into the plasma chamber without the use of a carrier gas, and the acrylate or methacrylate monomer is able to strike the plasma.

In another embodiment according to the present invention, the low pressure plasma polymerization as described above—selective and into the core of the material of which the item of footwear is made—is a low pressure plasma polymerization of an organosilane precursor monomer which is introduced into the plasma chamber by means of a carrier gas, said organosilane being of the formula (II), (III), (IV), (V) or (VI).

Y₁—X—Y₂ (II) or

—[Si(CH₃)_{q}(H)_{2-q}—X—]ₙ— (III) or

CH₂═C(R₁)—Si(R₂)(R₃)—R₄ (IV) or

R₅—Si(R₆)(R₇)—R₈ (V) or

CH₂═C(R₉)C(O)—O—(CH₂)ₚ—Si(R₁₀)(R₁₁)—R₁₂ (VI)
wherein for Formula (II) X is O or NH, Y₁ is —Si(Y₃)(Y₄)Y₅ and Y₂ is Si(Y_{3′})(Y_{4′})Y_{5′} wherein Y₃, Y₄, Y₅, Y_{3′}, Y_{4′}, and Y_{5′} are each independently H or an alkyl group of up to 10 carbon atoms; wherein at most one of Y₃, Y₄ and Y₅ is hydrogen, at most one of Y_{3′}, Y_{4′} and Y_{5′} is hydrogen; and the total number of carbon atoms is not more than 20.
wherein Formula (III) is cyclic where n is 2 to 10, wherein q is 0 to 2 and wherein the total number of carbon atoms is not more than 20.
wherein for Formula (IV) R₁ is H or an alkyl group, e.g. —CH₃, and wherein R₂, R₃ and R₄ are each independently H, an alkyl group of up to 10 carbon atoms or an alkoxy group —O—Z, wherein Z is preferably —CₜH₂ₜ₊₁, wherein t is 1 to 10.
wherein for Formula (V) R₅ is H or an alkyl group, e.g. —CH₃, and wherein R₆, R₇ and R₈ are each independently H, an alkyl group of up to 10 carbon atoms or an alkoxy group —O—Z, wherein Z is preferably —CₜH₂ₜ₊₁, wherein t is 1 to 10.
wherein for Formula (VI) R₉ is H or an alkyl group, e.g. —CH₃, wherein p is from 0 to 10, and wherein R₁₀, R₁₁ and R₁₂ are each independently H, an alkyl group of up to 10 carbon atoms or an alkoxy group —O—Z, wherein Z is preferably —CₜH₂ₜ₊₁, wherein t is 1 to 10.

The alkyl groups may be straight or branched-chain but straight groups are preferred. Such alkyl groups are aptly methyl or ethyl groups of which methyl is preferred. Aptly all of Y₃, Y₄, Y₅, Y_{3′}, Y_{4′} or Y_{5′} are alkyl groups.

The alkoxy groups may be straight, branched-chain or cyclic but straight groups are preferred. Such alkoxy groups are aptly methoxy or ethoxy groups.

The monomer of Formula II may be one containing six methyl groups. Aptly the monomer of Formula II is hexamethyldisiloxane. Aptly the monomer of Formula II is hexamethyldisilazane.

The monomer of Formula III may be one wherein n is 3, or n is 4, or n is 5, or n is 6. Aptly the monomer of Formula III is octamethylcyclotetrasiloxane. Aptly the monomer of Formula III is hexamethylcyclotrisilazane.

Preferably the monomer employed in this invention is hexamethyldisiloxane or hexamethyldisilazane.

The organosilane precursor monomer may be introduced to a plasma chamber by means of a carrier gas. Preferably, the carrier gas is selected from Hz, N₂, O₂, N₂O, CH₄, He or Ar, and/or any mixture of these gases. In one preferred process, a single carrier gas is used. This is most preferably O₂ or Ar.

Preferably the amount of carrier gas used together with the organosilane is about 1% to about 50% carrier gas/gases based on the flow of monomer. Preferably, about 5% to about 30% carrier gas is used, e.g. about 10% carrier gas.

The present invention also concerns in an aspect a method for coating an item of footwear by low-pressure plasma polymerization coating wherein the low pressure plasma polymerization uses a monomer as described here above, in particular according to formulas (I) to (VI), and further in this document.

Preferably, the plasma chamber comprises one or more electrode layers, which may be radiofrequency electrode layers or ground electrode layers, to generate an electromagnetic field.

Preferably, the or each radiofrequency electrode generates a high frequency electric field at frequencies of from 20 kHz to 2.45 GHz, more preferably of from 40 kHz to 13.56 MHz, with 13.56 MHz being preferred.

In order to perform the low pressure plasma polymerization step, the plasma chamber is evacuated to a set low base pressure. Next, one or more monomer inlets are opened to allow a constant flow of monomer, optionally together with a carrier gas, to enter the plasma chamber.

Preferably, an outgassing and/or a pre-treatment step are performed before the low pressure plasma polymerization process.

When the monomer is an acrylate or a methacrylate according to formula (I), the monomer is able to strike the plasma. Consequently a carrier gas is not needed to strike the plasma.

When the monomer is an organosilane monomer according to any of formulae (II) to (VI), a carrier gas may be used to strike the plasma. Whether a carrier gas is used or not depends on the monomer used.

Upon stabilization of the monomer, optionally combined with a carrier gas, to a set work pressure in the plasma chamber, a power is applied to the radiofrequency electrode or electrodes to generate an electromagnetic field. A plasma is struck, and the monomer molecules become activated. The substrates or products in the plasma chamber act as an initiation promoter or facilitator for the initiation of the plasma polymerization reaction, which will start upon contact of the activated monomer molecules, and will continue as long as there are activated monomer molecules present in the plasma chamber. During the plasma polymerization process, there is a constant flow of fresh monomer, optionally combined with a carrier gas, into the plasma chamber to keep the polymerization going.

Once a set plasma polymerization duration has been reached, the power applied to the radiofrequency electrode or electrodes is turned off, and the chamber is brought back to atmospheric pressure to allow removal of the treated products from the chamber.

The plasma polymerization time is determined in function of the design and materials of which the item of footwear is made, in order to obtain polymerization not only at the surface of the footwear material, but also into the core such as upper fabric covered by decorative and/or functional plastic tapes or prints, to obtain substantial better protection against water penetration and ingress, leading to dryer feet, no cooling down of the feed, reduced weight gain and drying time, and no wet outer fabric.

Preferably, the plasma polymerization time, expressed in the time that a power is applied to the electrodes, is from about 30 seconds to about 45 minutes, more preferably from about 45 seconds to about 30 minutes, such as from 1 minute to 25 minutes, such as 25, 24, 23, 22, 21, 20, 19, 18, 17, 16, 15, 14, 13, 12, 11, 10, 9, 8, 7, 6, 5, 4, 3, 2, or 1 minute.

The plasma polymerization may be continuous plasma polymerization. The plasma polymerization may be pulsed wave polymerization. Whether a continuous plasma or a pulsed plasma is used for the polymerization, depends on the chemistry used and on the volume and design of the plasma chamber.

Preferably, in a 1836 litre plasma chamber, the applied power for the coating process, when applied in continuous wave mode, is approximately 5 to 5000 W, more preferably approximately 10 to 2500 W, even more preferably approximately, say 15 to 2000 W, for example 20 to 1500 W, say 25 to 1000 W, say 30 to 750 W, say 35 to 500 W, say 500, 475, 450, 425, 400, 375, 350, 325, 300, 275, 250, 225, 200, 190, 180, 175, 170, 160, 150, 140, 130, 125, 120, 110, 100, 95, 90, 85, 80, 75, 70, 65, 60, 55, 50, 45, 40, or 35 W.

Preferably, in a 1836 litre plasma chamber, the applied power for the coating process, when applied in pulsed wave mode, is approximately 5 to 5000 W, more preferably approximately 10 to 2500 W, even more preferably approximately, say 20 to 1500 W, for example 30 to 1000 W, say 50 to 900 W, say 75 to 800 W, say 100 to 750 W, say 750, 725, 700, 675, 650, 625, 600, 575, 550, 525, 500, 475, 450, 425, 400, 375, 350, 325, 300, 275, 250, 225, 200, 190, 180, 175, 170, 160, 150, 140, 130, 125, 120, 110, or 100 W.

Preferably, when in pulsed power mode, the pulse repetition frequency may be from 100 Hz to 10 kHz having a duty cycle from approximately 0.05 to 50%, with the optimum parameters being dependent on the monomer used.

In a 1836 litre plasma chamber, used to apply a coating on 48 pairs of footwear in one single batch, the operating pressure for the coating step is approximately 10 to 500 mTorr, preferably approximately 15 to 200 mTorr, more preferably approximately 20 to 150 mTorr, say 30 to 100 mTorr, say less than 100, 90, 80, 70, 60, 50, 40, 30 mTorr.

Preferably, the method includes the step of applying a polymer coating having a thickness of from 10 to 1000 nm on the outer surfaces as well as on the internal surfaces, more preferably of from 20 to 750 nm, even more preferably of from 50 to 500 nm, e.g. 500, 450, 400, 350, 300, 250, 200, 150, 100, 75 or 50 nm.

In the current invention, when using acrylate monomers or methacrylate monomers according to formula (II), super-hydrophobic surfaces can be created with contact angles for water of more than 100°, say 101, 102, 103, 104, 105, 106, 107, 108, 109, 110, 111, 112, 113, 114, 115, 116, 117, 118, 119 or 120° according to ASTM D5946-04.

The same coatings, deposited from methacrylate and acrylate monomers according to formula (I) are super-oleophobic with oil repellency levels above or above and including 1, 1.5, 2, 2.5, 3, 3.5, 4, 4.5, 5, 5.5, 6, 6.5, 7, 7.5 or 8 for example up to 6 according to ISO14419, say up to or up to and including 4, 4.5, 5, 5.5, 6, 6.5, 7 7.5, or 8.

In the current invention, when using organosilane monomers according to any of formula (II) to formula (VI), hydrophobic surfaces can be created with contact angles for water of more than 90°, say 91, 92, 93, 94, 95, 96, 97, 98, 99, 100, 101, 102, 103, 104, 105, 106, 107, 108, 109 or 110° according to ASTM D5946-04.

The water contact angle and/or oil repellency level obtained depend on the monomer used, any carrier gases that may be used optionally, on the process conditions used, but also on the substrate onto which the nanocoating is deposited, e.g. polymer used, weight and thickness of the material, degree of openness, material construction (woven fabric, non-woven fabric, mesh, foam), etc.

Preferably, the method includes applying a polymer coating having a uniformity variation of the contact angles for water of less than 10° according to ASTM D5946-04 and, for nanocoatings deposited from methacrylate or acrylate monomers according to formula (I), a uniformity variation of the oil repellency of less than 0.5 according to ISO14419.

By using the method described above, a low pressure plasma coating is deposited on the outer and internal surfaces of an item of footwear, by applying the coating selectively and with penetration into the core of the footwear materials.

The applicants have surprisingly discovered that with a method according to the present invention, a water and/or oil repellent nanocoating is deposited not only on the outer surface of the upper material of the item of footwear, but also on the internal surfaces and even the surfaces which are shielded from direct exposure to the plasma by decorative and/or functional plastic tape or printing.

By using this inventive process according to the invention, the technical problem that is solved is not a single problem, but a combination of problems. Prior art documents fail to solve all these technical problems with a single method or solution.

The present application improves on the foregoing prior art documents by providing a method which, surprisingly, solves these technical problems all together in a single method. This is not obvious over the prior art, since the prior art solutions for keeping the feet dry are limiting the breathability of the item of footwear, and the prior art solution for reduction of the weight gain do not offer a solution for keeping the feet dry since only the outer surface of the upper material of the item of footwear receives the coating. Combination of these two prior art solutions would lead to an item of footwear with limited breathability, which would not offer a solution for sweat generated on the inside. Further, since only the outer surface of the upper material of the item of footwear would be coated, water ingress is not maximally reduced, since the inside of the upper material is not protected against liquids.

The technical problems solved by the invention described above include, but are not limited to:
Keeping the feet dry from outer liquids, such as rain and snow and the like;
Keeping the feet dry from sweat generated inside upon use;
Reduction of the weight gain of the footwear during use with resulting reduction in drying time (so-called “quick dry effect”);
Preventing the feet from cooling down.

The following non-limiting examples make these properties clear and show the benefit in using the method and nanocoatings of the present invention on footwear in general.

### EXAMPLES

In order that the invention may be more readily understood, it will now be described by way of the following non-limiting examples.

### Example 1: Benefit of Degassing Prior to Coating

A 680 litre chamber, designed to contain up to 40 pairs of footwear, was in its empty state pumped down to a pre-set degassing pressure of 20 mTorr, after which all inlets and outlets were closed off. The pressure increase over 60 seconds was measured and was 10 mTorr.

The same chamber was now fully loaded with sports shoes from which the laces had been removed. In a first process, the degassing level of said footwear was determined by pumping down the chamber to the same pre-set degassing pressure of 20 mTorr. Next, all inlets and outlets were closed off, and the pressure increase over 60 seconds was measured. The total pressure increase was 100-120 mTorr, which is at least 10 times higher than for an empty vacuum chamber. Next, a coating process according to Table 1 was performed, including a pre-treatment step. The oil level of the coated items of footwear was measured afterwards according to ISO14419 and was level 1.

The same experiment has been repeated, where after pumping down to the pre-set degassing pressure of 20 mTorr the pumping down was continued for 10 more minutes. Then, all inlets and outlets were closed off, and the pressure increase was found to be 35-40 mTorr. Next, a coating process according to Table 1 was performed, including a pre-treatment step. The oil level of the coated items of footwear was measured afterwards according to ISO14419 and was level 4.

In both experiments, the laces were coated separately by a method according to Table 2 and were afterwards placed back in the coated item of footwear.

An uncoated shoe of the same type, e.g. the left shoe of a pair including uncoated laces, was used for testing the Direct Weight Gain and the Drying Time. Also one item of footwear including laces coated according to the process with insufficient degassing and one item of footwear coated according to the process with sufficient degassing, were used for testing the Direct Weight Gain and the Drying Time.

The Direct Weight Gain and the Drying Time are determined after a test that simulates the daily use of the item of footwear. This test is carried out as following:
Weigh the item of footwear prior to submersion (dry weight);
Put the item of footwear at the foot to simulate actual use of the item of footwear;
Soak the foot with the item of footwear for 60 seconds horizontally in a vessel filled with water at room temperature (23±2° C.) up to the height where the foot and leg come out of the item of footwear;
Take the foot with the item of footwear out of the vessel, and take the footwear off from the foot;
Shake out the item of footwear by hand 20 times (up-down movement);
Weight again the item of footwear (tested item of footwear).

The different in weight between the tested item of footwear and the dry item of footwear (weight before simulation of use test), is the Direct Weight Gain, expressed in grams. The Direct Weight Gain expressed in % is the Direct Weight Gain in grams divided by the dry weight of the item of footwear multiplied by 100.

Now, the item of footwear is hung semi-horizontally with opening for the feet oriented downwards to allow drying. Every 5 minutes, the item of footwear is weighted again, until the weight increase (actual weight minus the dry weight before submersion) is 5% or less of the dry weight of the item of footwear. When this is reached, the required time to reach this is referred to as the Drying Time. For example, for a dry weight of 100 grams, the item is considered dry when the weight increase is 5 grams or less (item of footwear has weight of 105 grams or less).

TABLE 1
Process parameters for coating items
of footwear in a 680 litre chamber

| Parameter | Value | |
|---|---|---|
| Pre-treatment | | |
| Gas | Argon | |
| Flow | 500-1500 | sccm |
| Treatment time | 1-10 | min |
| Power | 100-1000 | W |
| Frequency | 13.56 | MHz |
| Frequency mode | Cw | |
| Plasma Zone | | |
| Coating time | 10-20 | min |
| Temperature walls | 40-50° | C. |
| Monomer | 1H,1H,2H,2H-Perfluorooctyl | |
| | acrylate | |
| Flow | 30-100 | sccm |
| Electrodes & Generator | | |
| Power during coating | 50-500 | W |
| Frequency | 13.56 | MHz |
| Frequency mode | cw | |
| Temperature RF electrode | 30-50° | C. |
| Pressure | | |
| Base pressure | 10-50 | mTorr |
| Work pressure | 20-150 | mTorr |
| Oleophobicity Level | 5 | |
| (ISO 14419-2010) | | |

TABLE 2
Process parameters for laces in a 490 litre chamber

| Parameter | Value | |
|---|---|---|
| Pre-treatment | | |
| Gas | Argon | |
| Flow | 100-1000 | sccm |
| Treatment time | 1-10 | min |
| Power | 100-1000 | W |
| Frequency | 13.56 | MHz |
| Frequency mode | Cw | |
| Plasma Zone | | |
| Coating time | 10-20 | min |
| Temperature walls | 40-50° | C. |
| Monomer | 1H,1H,2H,2H-Perfluorooctyl | |
| | acrylate | |
| Flow | 20-50 | sccm |
| Electrodes & Generator | | |
| Power during coating | 50-500 | W |
| Frequency | 13.56 | MHz |
| Frequency mode | cw | |
| Temperature RF electrode | 30-50° | C. |
| Pressure | | |
| Base pressure | 10-50 | mTorr |
| Work pressure | 20-150 | mTorr |
| Oleophobicity Level | 5 | |
| (ISO 14419-2010) | | |

Table 3 gives the summary of the test results in terms of oil repellency, Direct Weight Gain and Drying Time. It is clear that there is a huge, significant improvement when the item of footwear is coated, and that the results are further increased by a thorough degassing of the items of footwear.

The thoroughly degassed item of footwear has a Direct Weight Gain of only 3.4%, which is below 5%, so that the Drying Time is considered to be 0 minutes. For the uncoated item of footwear, the Direct Weight Gain of 18.6% clearly exceeds the 5%. For the coated item of footwear with less thorough degassing, the Direct Weight Gain of 12.7%, which is less than the Direct Weight Gain of the uncoated item, but which clearly exceeds the 5%.

The Drying Time for a thoroughly degassed item of footwear (sports shoe in this example) is reduced by 100% compared to an uncoated item of footwear and even to a coated item with less thorough degassing. The Drying Time for a thoroughly degassed item of footwear is thus 0% (ZERO) of the Drying Time of an uncoated item of footwear and 0% of the Drying Time of a coated item of footwear with less thorough degassing.

The Direct Weight Gain for a thoroughly degassed item of footwear (sports shoe in this example) is reduced by 81.6% compared to an uncoated item of footwear and by 72.9% compared to a coated item of footwear with less thorough degassing. The Direct Weight Gain for a thoroughly degassed item of footwear is thus only 18.4% of the Direct Weight Gain of an uncoated item of footwear and only 27.1% of the Direct Weight Gain of a coated item of footwear without thorough degassing.

TABLE 3
Test results in function of outgassing level

| | Pressure | | Outgassing | | Oil repellency | Direct weight | Drying time | |
|---|---|---|---|---|---|---|---|---|
| Coated? | increase | | level | | level | gain (%) | (5%)(min) | |
| Uncoated | / | | / | | Level 0 | 18.6% | 102 | min |
| Coated | 100-120 | mTorr | 90-110 | mTorr | Level 1 | 12.7% | 61 | min |
| Coated | 35-40 | mTorr | 25-30 | mTorr | Level 4 | 3.4% | 0 | min |

### Example 2: Penetration into Core of Material

2.1 Penetration into Core of Material

An item of footwear for running was coated according to the parameters in Table 4, including degassing, pre-treatment and coating steps (results given as “Coated 1” in table 4C). The fasteners—laces—were removed prior to coating and were coated separately in a 490 l chamber, which can contain up to 250 or more laces in one batch, according to Table 2.

Before placing this item of footwear into the plasma chamber, the complete inside, including the tongue and the insole, were covered with several layers of paper tape, to shield the inside of the footwear from direct exposure to the plasma. Even the opening where the foot enters the footwear was closed by several layers of tape.

To show the impact of proper degassing on the penetration into core of material, the same type of footwear for running was coating according to the parameters in Table 4B, including a pre-treatment and a coating step, but no degassing step (results given as “Coated 2” in table 4C). The fasteners—laces—were removed prior to coating and were coated separately in a 490 l chamber, which can contain up to 250 or more laces in one batch, according to Table 2.

Before placing this item of footwear into the plasma chamber, the complete inside, including the tongue and the insole, were covered with several layers of paper tape, to shield the inside of the footwear from direct exposure to the plasma. Even the opening where the foot enters the footwear was closed by several layers of tape. Degassing was performed by continuing pumping, i.e. by continuing evacuating the vacuum chamber, even after base pressure was reached, and this for another 10 minutes (pumpdown time). After this degassing step, the inlets and outlets were closed and the pressure increase was measured for over a wait time. This pressure increase was around 20 mTorr after 30 seconds, around 35 mTorr after 60 seconds, and around 50 mTorr after 120 seconds, hence a degassing level of the chamber of less than 50 mTorr was achieved. A pre-treatment and coating step with the parameters as in table 4 were subsequently performed.

After coating, the tape was removed, and the coated item of footwear was compared to the same footwear, but uncoated. The upper fabric of the running shoe is a porous mesh which is highly hydrophilic for the untreated shoe. The upper fabric for the coated shoe—coated according to Table 4—was after coating super-hydrophobic, with water contact angles of 110° and more (“Coated 1” in table 4C). Also the inside of the footwear, which was covered by the tape during coating, and which is hydrophilic before coating, was after coating surprisingly super-hydrophobic with water contact angles of 110° and more. Furthermore, as both the inside of the footwear and the outside of the footwear had water contact angles of 110° and more, it can be safely assumed that any internal surfaces will also have water contact angles of 110° and more. Also, it becomes clear that a method according to the present invention, which comprises degassing an item of footwear prior to the plasma polymerization coating process, leads to coatings which are of uniform quality for inner surfaces, outer surfaces and internal surfaces.

The same measurement was done on the footwear coated according to Table 4B, i.e. without the degassing step, showing a water contact angle of 110° and more for the upper fabric of the coated shoe. However, it was noticed that the inside of the footwear, which was covered by tape during coating, and which is hydrophilic before coating, had a significantly lower water contact angle after coating. The water contact angle was only 100° to 110°, which is hydrophobic but no longer super-hydrophobic, and which is quite clearly less than the water contact angle achieved on the inner surfaces of the item of footwear using the previous process which comprises a degassing step. Furthermore, from the difference in water contact angle between the inner and outer surfaces, one can assume that also the internal surfaces have a water contact angle of less than 110°. Also, this indicates that a plasma coating method without degassing step leads to coatings on the outer surfaces which have a substantially different quality and different characteristics as the coatings on the inner or internal surfaces. The results are summarized in Table 4C.

This clearly shows that according to the method of the present invention, a coating is deposited not only at the outer surface of the upper material of the footwear, but also at the internal and inner surfaces.

This clearly shows the impact of a proper degassing on the penetration into the core of materials as well.

TABLE 4
Process parameters for selective coating throughout
the structure of footwear in a 1836 litre chamber

| Parameter | Value | |
|---|---|---|
| Outgassing | | |
| Pumpdown time | 10 | min |
| Wait time | 30-120 | sec |
| Maximum allowed pressure | 5-50 | mTorr |
| increase inside chamber | | |
| Pre-treatment | | |
| Gas | Argon | |
| Flow | 500-1500 | sccm |
| Treatment time | 1-10 | min |
| Power | 100-1000 | W |
| Frequency | 13.56 | MHz |
| Frequency mode | Cw | |
| Plasma Zone | | |
| Coating time | 10-20 | min |
| Temperature walls | 40-50° | C. |
| Monomer | 1H,1H,2H,2H-Perfluorooctyl | |
| | acrylate | |
| Flow | 30-100 | sccm |
| Electrodes & Generator | | |
| Power during coating | 50-500 | W |
| Frequency | 13.56 | MHz |
| Frequency mode | cw | |
| Temperature RF electrode | 30-50° | C. |
| Pressure | | |
| Base pressure | 10-50 | mTorr |
| Work pressure | 20-150 | mTorr |
| Oleophobicity Level | 5 | |
| (ISO 14419-2010) | | |

TABLE 4B
Process parameters for selective coating throughout
the structure of footwear in a 1836 litre chamber

| Parameter | Value | |
|---|---|---|
| Pre-treatment | | |
| Gas | Argon | |
| Flow | 500-1500 | sccm |
| Treatment time | 1-10 | min |
| Power | 100-1000 | W |
| Frequency | 13.56 | MHz |
| Frequency mode | Cw | |
| Plasma Zone | | |
| Coating time | 10-20 | min |
| Temperature walls | 40-50° | C. |
| Monomer | 1H,1H,2H,2H-Perfluorooctyl | |
| | acrylate | |
| Flow | 30-100 | sccm |
| Electrodes & Generator | | |
| Power during coating | 50-500 | W |
| Frequency | 13.56 | MHz |
| Frequency mode | cw | |
| Temperature RF electrode | 30-50° | C. |
| Pressure | | |
| Base pressure | 10-50 | mTorr |
| Work pressure | 20-150 | mTorr |
| Oleophobicity Level | 5 | |
| (ISO 14419-2010) | | |

TABLE 4C
Water contact angles on outer and inner
surfaces according to Example 2.1.

| | | Pre- | Coat- | WCA outer | WCA inner |
|---|---|---|---|---|---|
| Sample | Degassing? | treatment | ing? | surface | surface |
| Uncoated | No | No | No | 0° | 0° |
| Coated 1 | Yes | Yes | Yes | ≥110° | ≥110° |
| Coated 2 | No | Yes | Yes | ≥110° | 100°-110° |

### 2.2 Abrasion Resistance—Simulated Use

In order to get insight in the daily use of footwear, and especially the abrasion upon use, a coated item of footwear for sports applications is rubbed manually with a tissue in a back-and-forth movement. The item of footwear was coated according to the process parameters in Table 4 wherein the laces had been removed prior to coating, and the outsole was masked with a masking tape to prevent coating deposition onto the outsole.

This test is testing how good the coating adhesion to the material is, as well as how good the coating was deposited into the core of the material, since the possible damage of the coating at the surface would lead to a reduction in contact angle for water.

The contact angle for water of the rubbed mesh surface is measured in function of the number of abrasion cycles. It is clear from FIG. 2 that even after 1000 abrasion cycles the water contact angle of the coated mesh fabric is still in the range of the footwear as coated, before starting the abrasion simulation.

### Example 3: Reduced Weight Gain and Improved Drying Time

### 2.1 Reduction in Weight Gain During Use

### 2.1.1 Test 1

A sports shoe was coated in a batch process in a machine with a chamber volume of 1836 litres, according to the process parameters of Table 4. This plasma chamber can contain up to 40-60 pairs of footwear. Upon coating, the fasteners were removed from the item of footwear and were coated in a separate process according to Table 2 (selective coating of items of footwear). The equipment used to coat the fasteners was a 490 litre chamber, in which 150 to 250 fasteners (laces) can be coated in a single batch.

The coating process of the footwear comprises an outgassing step, a pre-treatment step and a plasma polymerization coating step. The outgassing step is performed to remove moisture, air and other gases from the chamber and the items of footwear prior to starting the pre-treatment process. The pre-treatment process removes contamination on the material, in order to obtain a better coating throughout the material structure. The applicants have discovered that this selective coating throughout the footwear materials leads to an enhanced performance of the coated items of footwear.

Afterwards, the laces were placed back into the sports shoe. The sports shoe was submersed during 1 minute in a 10-litre bucket of water, and then the shoe was shaken out 20 times and weighted afterwards. The same test was done for an identical but uncoated shoe.

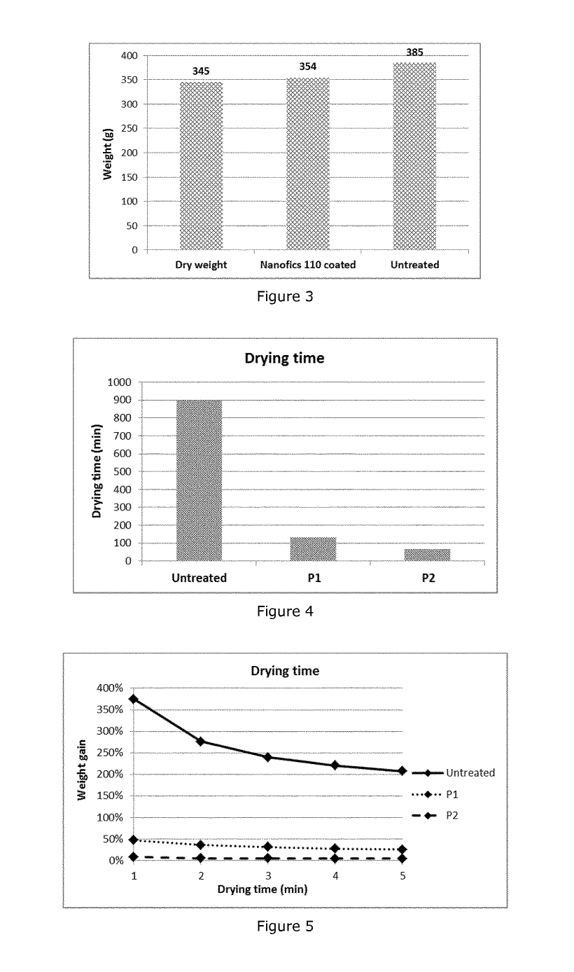

FIG. 3 presents the test results. It is clear that after only one minute submersion, the untreated sports shoe takes up 40 grams of water, while the plasma coated sports shoe has a weight increase of only 9 grams, meaning a weight gain reduction of 31 grams, which is 9% of the dry weight of the sports shoe.

### 2.1.2 Test 2: Shower Direct Weight Gain and Durability

Further, 6 different types of sport footwear for running and jogging, from different brands, have been coated according to the process parameters of Table 4. Upon coating, the fasteners were removed from the item of footwear and were coated in a separate process according to Table 2 (selective coating of items of footwear).

A Footwear Shower Test has been performed for each of the 6 different types, both on an uncoated shoe and on a coated shoe. The Footwear Shower Test was carried out as follows:
Weigh the item of footwear prior to submersion to obtain the dry weight;
Put a hydrophobic coated sock on a plastic foot mold;
Place the sock-mold combination in the footwear;
Close the fasteners firmly;
Place the footwear with mold and sock in the vessel for the Footwear Shower Test;
Spray 500 ml water onto the footwear, over a duration of 60 seconds;
Allow footwear to drip out for 10 seconds by placing upside down;
Take out sock-mold combination;
Pour ingressed but not absorbed water out in a swift movement;
Weight again the item of footwear (tested item of footwear; final weight).

The Shower Direct Weight Gain in % was calculated as described above (weight increase in grams divided by the dry weight, multiplied by 100), as well as the reduction of the Shower Direct Weight Gain coming from applying a coating according to the present invention.

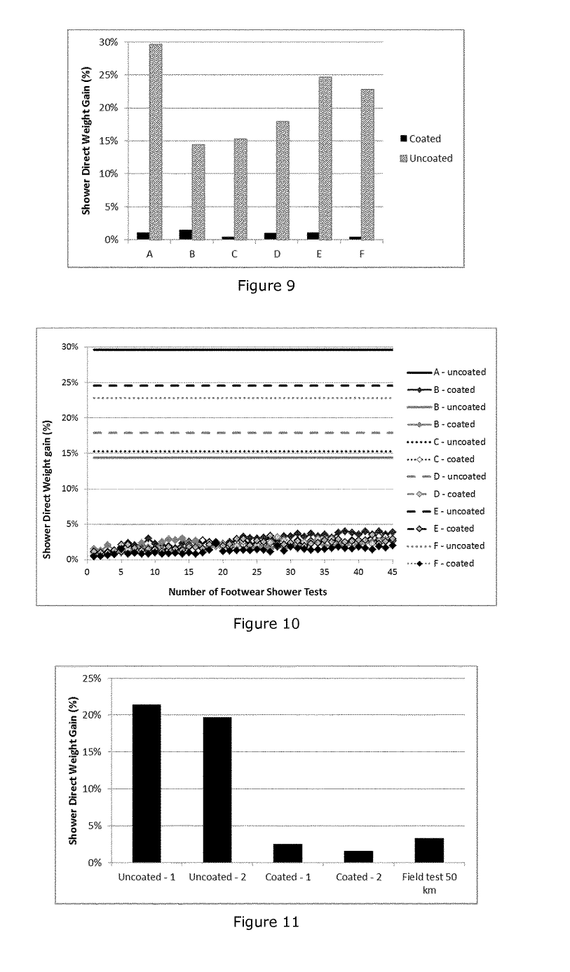

Table 6 and FIG. 9 show the Shower Direct Weight Gain (%) for all 6 types, for coated and uncoated shoes, and the reduction in Shower Direct Weight Gain (%). All coated footwear have a Shower Direct Weight Gain of 1.5% or lower, while all uncoated footwear have a Shower Direct Weight Gain of at least 14.4%, up to even 29.6%. A reduction of at least 89.6% is measured, which means that the weight gain of coated footwear is 10.4% or lower than the weight gain of the respective uncoated footwear.

TABLE 6
Shower Direct Weight Gain values

| | Shower Direct Weight Gain (%) | | |
|---|---|---|---|
| Type | Uncoated | Coated | Reduction (%) |
| A | 29.6% | 1.1% | 96.3% |
| B | 14.4% | 1.5% | 89.6% |
| C | 15.3% | 0.4% | 97.4% |
| D | 17.9% | 1.0% | 94.4% |
| E | 24.6% | 1.1% | 95.5% |
| F | 22.8% | 0.4% | 98.2% |

The Footwear Shower Test was then repeated a further 44 times on the coated items. The results are presented in FIG. 10, from which it is clear that even after 45 Footwear Shower Tests the Shower Direct Weight Gain is still very good, max. value is 3.3%, which is still a significant reduction compared to the uncoated items.

### 2.1.3 Test 3: Shower Direct Weight Gain and Durability

Another type of footwear for running was coated according to the process parameters of Table 4. Upon coating, the fasteners were removed from the item of footwear and were coated in a separate process according to Table 2 (selective coating of items of footwear).

One coated item was then used for field testing, wherein a person went running 10 times, each time 5 km, outdoors, for a total of 50 km.

A Footwear Shower Test was then performed on 2 uncoated footwear of this type, on 2 coated footwear of this type (without field test), and on the field tested item. It is clear from Table 7 and FIG. 11 that the field tested item has a Shower Direct Weight Gain similar to the coated but not field tested shoes, and that the Shower Direct Weight Gain of the coated items is at least 83.2% lower than the Shower Direct Weight Gain of the uncoated items (Field test 50 km compared to Uncoated-2).

TABLE 7
Shower Direct Weight Gain values

| Description | Shower Direct Weight Gain (%) |
|---|---|
| Uncoated - 1 | 21.4% |
| Uncoated - 2 | 19.7% |
| Coated - 1 | 2.5% |
| Coated - 2 | 1.6% |
| Field test 50 km | 3.3% |

### 2.2 Quick Drying Effect

### 2.2.1 Shower Drying Time

The footwear of 2.1.3. Test 3 were dried in vertical position after the Footwear Shower Test. The Shower Drying Time was measured by weighing the footwear every 5 minutes for 1 hour, then every 15 minute until 5 hours drying time, then every 30 minutes until they were dry.

The footwear was considered dry when the weight gain was decreased to 3% or lower.

Table 8 gives the Shower Drying Time for the footwear from 2.1.3. Test 3:

TABLE 7
Shower Drying Time values

| Description | Shower Drying Time |
|---|---|
| Uncoated - 1 | 13 h 30 |
| Uncoated - 2 | 11 h 30 |
| Coated - 1 | 0 minutes |
| Coated - 2 | 0 minutes |
| Field test 50 km | 5 minutes |

It is clear from Table 7 that the uncoated footwear need a long time to dry, with an average Shower Drying Time of 12 h30 (750 minutes). For the coated—not field tested footwear, the Shower Drying Time is reduced by 100% compared to the Shower Drying Time of the uncoated footwear. For the field tested footwear, the Shower Drying Time is reduced by 96.7%, or the Shower Drying Time of the field tested footwear is only 3.3% of the average Shower Drying Time of the uncoated footwear.

### 2.2.2 Foam Structure

An open cell structure used as foam or mesh in footwear was coated with two different plasma processes, P1 and P2, according to Table 4. The only difference between P1 and P2 is the coating time (P2 longer than P1).

They were submersed in a vessel with a weight of 5 kg put on top to force water ingress to a large extent (worst case scenario), for 5 minutes. Then they were taken out of the vessel and they were dried at the ambient air. The drying time was measured and is defined as the time needed to reach a weight within 5% weight gain compared to their dry weight. The same test was done on uncoated foam.

It is clear from FIG. 4 that the drying time is highly reduced by the deposition of a plasma coating according to the present invention.

### 2.2.3 Faux Fur

Faux fur as a pile weave, used to decorate items of footwear for leisure shoes, and used to insulate the inside (inner lining) of footwear for winter times and cold environments, is coated on roll using a process according to Table 5. Two processes have been done, P1 and P2, wherein the coating step speed of P2 is higher than that of P1 (shorter residence time in the plasma zone).

A4-sized sheets of untreated and plasma coated faux fur have been tested in a submersion test. They were placed in a basket under 10 cm of water at room temperature for 5 minutes, with a 2 kg weight placed on top of the basket to prevent the samples from rising and floating in the water. Afterwards, they were taken out of the basket and were allowed to drip out and dry in a vertical position. The weight gain compared to the dry weight was calculated after 1, 2, 3, 4 and 5 minutes drying time.

TABLE 5

| Parameter | Value | |
|---|---|---|
| Pre-treatment | | |
| Gas | Argon | |
| Flow | 500-1500 | sccm |
| Treatment speed | 6 | m/min |
| Power | 1000-5000 | W |
| Frequency | 13.56 | MHz |
| Frequency mode | cw | |
| Plasma Zone | | |
| Length of plasma zone | 6 | m |
| Coating step speed | 2 | m/min |
| Tension | 1.5 kg (15N) | |
| Temperature walls | 40-50° | C. |
| Electrodes & Generator | | |
| Electrode configuration | M/RF/M/RF/RF/M/RF/M | |
| Plasma type | Primary | |
| Power during coating | 100-500 | W |
| Frequency | 13.56 | MHz |
| Frequency mode | cw | |
| Temperature RF electrode | 30-35° | C. |
| Monomer | 1H,1H,2H,2H-Perfluorooctyl | |
| | acrylate | |
| Flow | 50-150 | sccm |
| Pressure | | |
| Base pressure | 10-50 | mTorr |
| Work pressure | 20-80 | mTorr |
| Residence time in plasma | 3 | minutes |
| zone during coating | | |
| Oleophobicity Level | 5 | |
| (ISO 14419-2010) | | |

It is clear from FIG. 5 that untreated faux fur tends to take up a lot of moisture, specially the backing layer of the pile weave material. Once coated, the weight gain is decreased largely and the drying time is much shorter. When defining the drying time as the time needed to reach a weight gain of 5% or less, then P2 has a drying time of only 4 minutes, while the uncoated material still has a weight gain of 207% after 5 minutes drying.

### Example 4: Breathability

A polyester (PES) fabric has been coated on roll of 1.6 m width with a method according to the present invention, comprising a pre-treatment step and a plasma polymerization coating step, with the process parameters of Table 5. The same fabric was coated with a traditional pad-dry-cure coating process.

The breathability was tested on all fabrics and evaluated in terms of water vapour permeability and air permeability.

### 4.1 Water Vapour Permeability

Water vapour permeability is a degree for the transport of humidity inside the item of footwear, coming from the feet. Upon use, the temperature of the feet rises and sweat is produced. Release of water vapour and thus evaporated sweat, and of the heat, is essential for a good comfort for the end user of the footwear.

Water vapour permeability is tested according to ASTM E96 (1995), and measures the weight gain in g/m²·day of silica pellets. The weight gain is coming from absorption of water vapour that passed the fabric, while the fabric is placed in a closed environment at 20° C. and 65% relative humidity.

Every fabric has an water vapour permeability specific for the fabric, since the fabric structure, weave pattern, openness, polymer type, etc. may all influence the inherent water vapour permeability.

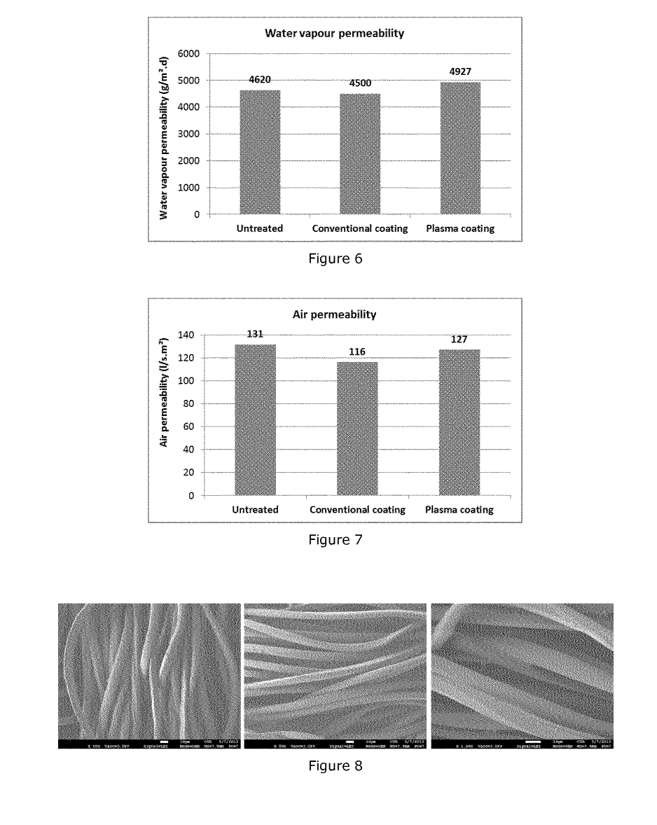

FIG. 6 presents the results of the water vapour permeability of the fabrics (untreated, conventionally coated and plasma coated).

It is clear that the water vapour permeability of plasma coated fabric is higher than that of fabric coated with a conventional pad-dry-cure process. More, the plasma coating enhances the water vapour permeability of the fabric as such, because the water vapour doesn't get absorbed by the textile fibres, where for the untreated fabric the fibres tend to absorb moisture to some degree. From FIG. 7 it is also clear that a conventional coating reduces the water vapour permeability of the tested fabric, since this coating tends to block the openings in the fabric, or at least reduces the dimensions of the openings in the fabric.

### 4.2 Air Permeability

The air permeability is a degree for heat release and openness of the fabric. It is measured according to ISO9237 (1995), measuring the amount of air passing through a fabric (in l/(s·m²)) when a constant pressure difference of 100-200 Pa is maintained at both sides of the fabric.

FIG. 7 presents the results of the air permeability of the fabrics (untreated, conventionally coated and plasma coated). The plasma coated samples are obtained using a process according to Table 5. It is clear that the air permeability of plasma coated fabric is higher than that of fabric coated with a conventional pad-dry-cure process, and is in the same range as the air permeability of the untreated fabric.

SEM-examination (FIG. 8) of PES fabric, uncoated, conventionally coated, and plasma coated according to Table 5 shows clearly that the plasma coating covers the individual yarns, but that the conventional coating covers multiple yarns, gluing these together and limiting the breathability.

1-12. (canceled)

13. Method for coating outer, internal and inner surfaces of an item of footwear with a water- and/or oil-repellent coating by a low-pressure plasma polymerization coating process, the item of footwear comprising an upper with covering elements which are applied to an outer surface of the upper, by degassing the item of footwear prior to said coating process, whereby said item of footwear is degassed to a degassing level of at most 20 mTorr (2.67 Pa) and/or whereby said item of footwear is degassed in a vacuum chamber until said vacuum chamber comprises a degassing level of at most 50 mTorr (6.67 Pa) by
pumping the plasma chamber down to a set low pressure, and
subsequently continuing the pumping down for a set time,
thereby depositing a coating also on the upper material of the footwear covered by covering elements.

14. Method according to claim 13, wherein said set low pressure to which the plasma chamber is pumped down, is equal to or higher than a set base pressure of the coating step or an optional pre-treatment step.

15. Method according to claim 13, comprising shielding parts of the item of footwear prior to said coating process, removing of parts of the item of footwear prior to said coating process, and/or separately coating parts of the item of footwear by said coating process prior to assembly of the parts into said item.

16. Method according to claim 13, wherein the low pressure plasma polymerization is preceded by a low pressure plasma pre-treatment step, preferably wherein the outgassing and the pre-treatment are combined in a single processing step.

17. Method according to claim 13, wherein the item of footwear is a sports shoe.

18. Method according to claim 13, wherein the low pressure plasma polymerization uses a monomer which is
CᵤF₂ᵤ₊₁C_{w}X_{2w}CR₁₃Y—OCO—C(R₁₄)═CH₂,
wherein u is 2 to 6, w is 0 to 9, X and Y are H, F, Cl, Br or I, R₁₃ is H or alkyl or a substituted alkyl, e.g. an at least partially halo-substituted alkyl, and R₁₄ is H or alkyl or a substituted alkyl, e.g. an at least partially halo-substituted alkyl.

19. Method according to claim 13, wherein the low pressure plasma polymerization uses a monomer which is an organosilane, wherein the organosilane is:
Y₁—X—Y₂ wherein X is O or NH, Y₁ is —Si(Y₃)(Y₄)Y₅ and Y₂ is Si(Y_{3′})(Y_{4′})Y_{5′} wherein Y₃, Y₄, Y₅, Y_{3′}, Y_{4′}, and Y_{5′} are each independently H or an alkyl group of up to 10 carbon atoms; wherein at most one of Y₃, Y₄ and Y₅ is hydrogen, at most one of Y_{3′}, Y_{4′} and Y_{5′} is hydrogen; and the total number of carbon atoms is not more than 20;
cyclic according to —[Si(CH₃)_{q}(H)_{2-q}—X—]ₙ— where n is 2 to 10, wherein q is 0 to 2 and wherein the total number of carbon atoms is not more than 20;
CH₂═C(R₁)—Si(R₂)(R₃)—R₄ wherein R₁ is H or an alkyl group, e.g. —CH₃, and wherein R₁, R₂ and R₃ are each independently H, an alkyl group of up to 10 carbon atoms or an alkoxy group —O—Z, wherein Z is preferably —CₜH₂ₜ₊₁, wherein t is 1 to 10;
R₅—Si(R₆)(R₇)—R₈ wherein R₅ is H or an alkyl group, e.g. —CH₃, and wherein R₆, R₇ and R₈ are each independently H, an alkyl group of up to 10 carbon atoms or an alkoxy group —O—Z, wherein Z is preferably —CₜH₂ₜ₊₁, wherein t is 1 to 10; or
—CH₂═C(R₉)C(O)—O—(CH₂)ₚ—Si(R₁₀)(R₁₁)—R₁₂ wherein R₉ is H or an alkyl group, e.g. —CH₃, wherein p is from 0 to 10, and wherein R₁₀, R₁₁ and R₁₂ are each independently H, an alkyl group of up to 10 carbon atoms or an alkoxy group —O—Z, wherein Z is preferably —CₜH₂ₜ₊₁, wherein t is 1 to 10.

20. Degassed item of footwear, comprising a degassing level of at most 20 mTorr, and/or said item of footwear located in a vacuum chamber, loaded with a number of items of footwear, said vacuum chamber comprising a degassing level of at most 50 mTorr, said item of footwear comprising an upper with covering elements which are applied to an outer surface of the upper.

21. Item of footwear comprising a water- and/or oil-repellent coating applied by a low-pressure plasma polymerization coating method according to claim 13, said item of footwear comprising an upper with covering elements which are applied to an outer surface of the upper, said coating applied on the outer surface of an upper of the item of footwear, as well as on internal surfaces and inner surfaces of the item of footwear, including on the upper material of the footwear covered by covering elements.

22. Item of footwear according to claim 20, said item of footwear comprising a Drying Time which is at most 10% of a Drying Time of the item of footwear when uncoated.

23. Item of footwear according to claim 20, said item of footwear comprising a Direct Weight Gain which is at most 20% of a Direct Weight Gain of the item of footwear when uncoated.

24. Low-pressure plasma polymerization coating apparatus for high-load coating of items of footwear, configured to perform a method according to claim 13, the apparatus comprising at least two pairs of electrodes, each pair comprising a ground electrode and a radiofrequency (RF) electrode for inducing a plasma and for applying a plasma polymerized coating onto items of footwear which can be placed in between the ground electrode and the RF electrode of a pair, whereby the distance between the ground electrode and the RF electrode of a pair is larger than 50 mm and smaller than 500 mm, and wherein the distance between the ground electrode of the first pair and the RF electrode of the second pair is larger than 1 mm and smaller than 50 mm, preferably said apparatus comprising slots in between each pair of electrodes, said slots preferably comprising means for placing one or more sample holders at variable or different positions, more preferably said apparatus comprising one or more sample holders inserted in said slots for holding the items of footwear or parts of the item of footwear, which are to be coated.
